(19) United States
(12) Patent Application Publication
(10) Pub. No.: US 2010/0274803 A1
(43) Pub. Date: Oct. 28, 2010

(54) Document Preparation Support Apparatus, Document Preparation Support Method, and Document Preparation Support Program

(75) Inventors: Kimiyoshi MACHII, Hitachinaka (JP); Takeshi Yokota, Hitachi (JP); Jinichiro Goto, Mito (JP); Mitsuru Obana, Mito (JP); Osamu Arai, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/769,224

(22) Filed: Apr. 28, 2010

(30) Foreign Application Priority Data
Apr. 28, 2009 (JP) 2009-109795

(51) Int. Cl. G06F 17/30

(52) U.S. Cl. 707/769; 707/E17.014

(57) ABSTRACT

A document preparation support apparatus outputs a knowhow and a response example for each critical passage of a document. The document preparation support apparatus includes a storage unit. The storage unit includes: first corresponding information that stores a knowhow in association with a search key for extracting a critical passage; and second corresponding information that stores a response example in association with a search key for extracting a critical passage. The document preparation support apparatus also includes a control unit. The control unit receives a document; extracts a critical passage from the received document using a prescribed search key from among the search keys; searches the first corresponding information and the second corresponding information using the search key used for the extraction to obtain a knowhow and a response example; and outputs the obtained knowhow and response example in association with the critical passage.

### CROSS REFERENCE TO RELATED APPLICATIONS

This application claims the benefit of Japanese Patent Application No. 2009-109795 filed on Apr. 28, 2009, the disclosure of which is incorporated herein by reference.

### BACKGROUND OF THE INVENTION

1. Field of the Invention

The present invention relates to a document preparation support apparatus, a document preparation support method, and a document preparation support program.

2. Description of the Related Art

Various techniques of efficiently preparing a document concerning an agreement between a plurality of parties concerned, such as a contract document, have been disclosed.

Japanese Laid-Open Patent Application, Publication No. 2006-65421 (paragraph [0004]) (to be referred to as Patent Document 1 hereinafter) discloses a system in which: contract patterns corresponding to contract types are sequentially displayed; a selection of a case required for each contract pattern is received; a template in accordance with the contract pattern or the case is displayed where necessary; and a contract document is finally prepared by editing the template by a user.

Japanese Laid-Open Patent Application, Publication No. 2003-108879 (paragraph [0008]) (to be referred to as Patent Document 2 hereinafter) discloses a system in which: a proposal similar to a request of a customer is obtained; a difference between information on a commodity currently possessed by the customer and each of candidate commodities to be proposed to the customer; the difference is compared to the customer's request to determine a commodity to be proposed from among the candidate commodities; and the obtained proposal is edited based on information on the determined commodity to be proposed.

In Patent Document 1, however, a template as a knowhow is associated with each of the cases (corresponding to a clause of the present invention). Thus, it is not possible to present a template using a passage described in a given clause as a key, which is not enough to minutely avoid a risk in a contract.

Further, Patent Document 1 does not disclose a technique in which, if a user finds a new risk, a new knowhow is created or an existing knowhow is updated for avoiding the risk.

Patent Document 2 requires extra time and labor for inputting information on a commodity currently possessed by the customer. This cannot inevitably avoid a possibility of neglecting an input of the information. Additionally, if there is no difference between the information on a commodity currently possessed by the customer and the information on a candidate commodity to be proposed to the customer (that is, if the candidate commodity meets a customer's request), the system does not give warning on a possible risk in the contract.

In light of the above problems, the present invention has been made in an attempt to provide a document preparation support apparatus and the like capable of supporting an efficient preparation of a contract document while utilizing information on previous contracts and knowhows and avoiding risks in a contract.

### SUMMARY OF THE INVENTION

A document preparation support apparatus outputs a knowhow and a response example for each critical passage. The document preparation support apparatus includes: a storage unit; and a control unit. The storage unit includes; first corresponding information that stores the knowhow in association with a search key for extracting a critical passage; and second corresponding information that stores a response example in association with a search key for extracting a critical passage. The control unit receives a document; extracts a critical passage from the received document using a prescribed search key from among the search keys; searches the first corresponding information and the second corresponding information using the prescribed search key used for the extraction to obtain a knowhow and a response example; and outputs the obtained knowhow and response example in association with the critical passage.

Other features and advantages of the present invention will become more apparent from the following detailed description of the invention, when taken in conjunction with the accompanying exemplary drawings.

### BRIEF DESCRIPTION OF THE DRAWINGS

FIG. 1A is a diagram illustrating an example of a request for proposal (to be referred to as a RFP hereinafter) according to an embodiment of the present invention. FIG. 1B is a diagram illustrating an example of a response document according to the embodiment.

FIG. 2A and FIG. 2 are diagrams each illustrating a configuration of a document preparation support apparatus according to the embodiment.

FIG. 3 is a diagram illustrating an example of a rule group database according to the embodiment.

FIG. 4A is a diagram illustrating an example of a phrase specifying search rule database according to the embodiment. FIG. 4B is a diagram illustrating an example of a phrase-phrase specifying search rule database according to the embodiment. FIG. 4C is a diagram illustrating an example of a phrase-numerical value specifying search rule database according to the embodiment. FIG. 4D is a diagram illustrating an example of a phrase with numerical value specifying search rule database according to the embodiment.

FIG. 5A is a diagram illustrating an example of rule-knowhow corresponding information according to the embodiment. FIG. 5B is a diagram illustrating an example of a knowhow database according to the embodiment.

FIG. 6A is a diagram illustrating an example of rule-template corresponding information according to the embodiment. FIG. 6B is a diagram illustrating an example of a template database according to the embodiment.

FIG. 7 is a diagram illustrating an example of a buffer data according to the embodiment.

FIG. 8 is a diagram illustrating an example of an output format according to the embodiment.

FIG. 9 is a diagram illustrating an example of a main window according to the embodiment.

FIG. 10 is a diagram illustrating an example of another main window according to the embodiment.

FIG. 11 is a diagram illustrating an example of a rule group selection window according to the embodiment.

FIG. 12A is a diagram illustrating an example of a rule edit window according to the embodiment. FIG. 12B is a diagram illustrating an example of a rule edit subwindow according to the embodiment.

FIG. 13A is a diagram illustrating an example of another rule edit window according to the embodiment. FIG. 13B is a diagram illustrating an example of another rule edit subwindow according to the embodiment.

FIG. 14A is a diagram illustrating an example of a knowhow template edit window according to the embodiment. FIG. 14B is a diagram illustrating an example of a response document edit window according to the embodiment.

FIG. 15 is a diagram illustrating an example of a new response input window according to the embodiment.

FIG. 16 is a diagram illustrating an example of a response list window according to the embodiment.

FIG. 17 is a flowchart of a critical passage extraction processing according to the embodiment.

FIG. 18 is a flowchart of a response document edit/preparation processing A according to the embodiment.

FIG. 19 is a flowchart of a response document edit/preparation processing B according to the embodiment.

FIG. 20 is a flowchart of a response document edit/preparation processing C according to the embodiment.

FIG. 21 is a flowchart of a knowledge edit/preparation processing according to the embodiment.

FIG. 22 is a diagram illustrating an example of a data sheet input window according to the embodiment.

### DETAILED DESCRIPTION OF THE EXEMPLARY EMBODIMENT

Next is described in detail an exemplary embodiment for carrying out the present invention with reference to the related drawings.

A contract document is generally prepared in such a repeated manner that a contractor draws up a draft, an owner revises it, the contractor again revises it, etc. If the parties to the contract finally agree to the revised draft, it becomes the contract document. A passage subjected to such a revision often relates to a contract condition on which there is a conflict of interest between the parties to the contract.

Description hereinafter is made assuming that a contract document related to a trade business.

### <Request for Proposal (RFP) and Response Document>

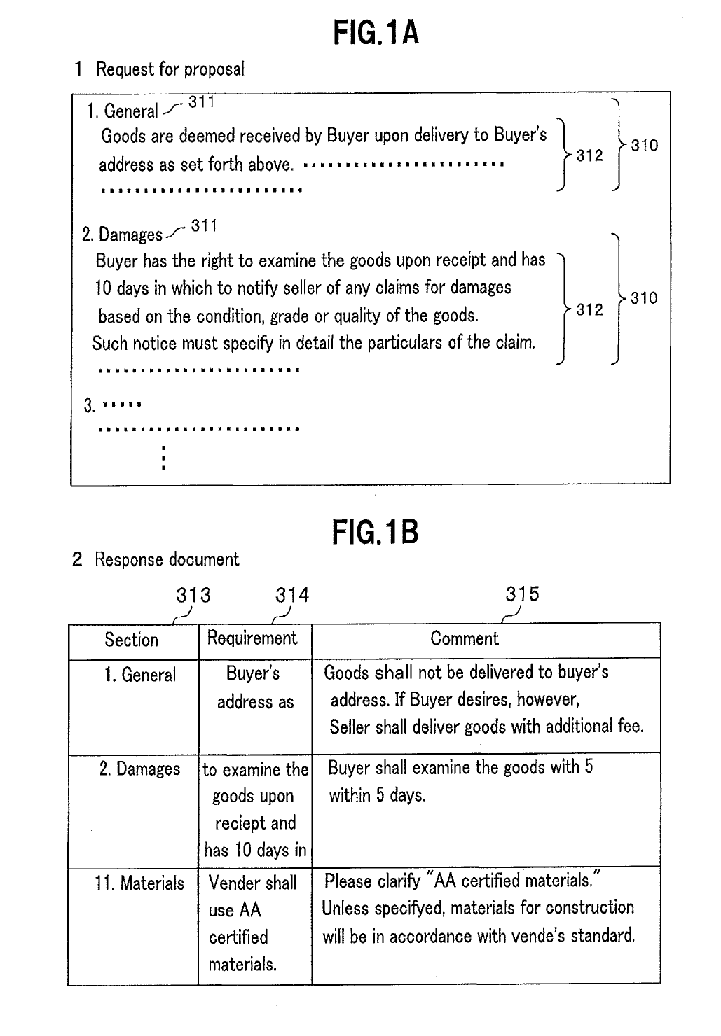

Below are described a RFP 1 and a response document 2 with reference to FIG. 1A and FIG. 1B, respectively.

In FIG. 1A, the RFP 1 is a draft of a contract document prepared by a contractor. The RFP 1 includes a plurality of clauses 310. The clause 310 includes a clause title 311 and a clause content 312.

In the first clause 310 of FIG. 1A, the clause title 311 is “1. General” and the clause content 312 is “Goods are deemed . . . ”.

In the second clause 310, the clause title 311 is “2. Damages” and the clause content 312 is “Buyer has the right . . . ”.

In FIG. 1B, the response document 2 is a paper describing a response for each critical passage (to be described in detail hereinafter) of the RFP 1 by the owner that receives the RFP 1 from the contractor.

A section column 313 includes the clause title 311 of the clause 310 containing a critical passage. A requirement column 314 includes the critical passage (more specifically, the critical passage and terms before and after the passage; to be described in detail hereinafter). A comment column 315 includes a response.

For example, the first row of the response document 2 describes that the clause content 312 of the clause 310 with the clause title 311 as “1. General” has a critical passage of “address” and that “Goods shall not be . . . ” is prepared in response to the critical passage.

The RFP 1 is typically exchanged between the parties to the contract. However, the response document 2 is not necessarily exchanged between the parties to the contract and may be made use of within the owner that receives the RFP 1 from the contractor. Further, the RFP 1 and the response document 2 may be exchanged within one business enterprise.

### <Document Preparation Support Apparatus>

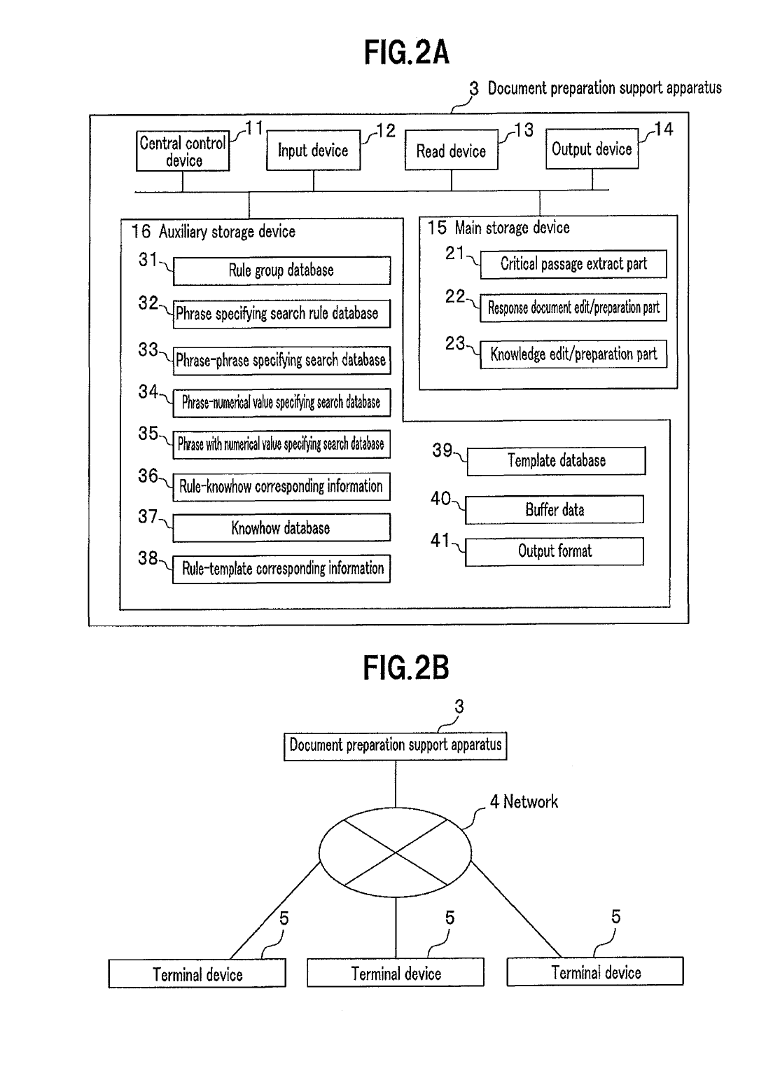

Next is described a document preparation support apparatus 3 with reference to FIG. 2A and FIG. 2B.

As shown in FIG. 2A, the document preparation support apparatus 3 is a generally-used computer and includes: a central control device 11; an input device 12 such as a keyboard and a mouse; a read device 13 such as a scanner; an output device 14; a main storage device 15; and an auxiliary storage device 16, all of which are connected to each other via a bus.

The auxiliary storage device 16 stores therein: a rule group database 31; a phrase specifying search rule database 32; a phrase-phrase specifying search rule database 33; a phrase-numerical value specifying search rule database 34; a phrase with numerical value specifying search rule database 35; a rule-knowhow corresponding information 36; a knowhow database 37; a rule-template corresponding information 38; a template database 39; a buffer data 40; and an output format 41 (to be described in detail hereinafter).

A critical passage extract part 21, a response document edit/preparation part 22, and a knowledge edit/preparation part 23 are programs. To simplify description, it is assumed herein that the parts 21 to 23 as programs directly perform their respective functions. Actually, however, it is the central control unit 11 that reads and loads the parts 21 to 23 as programs from the auxiliary storage unit 16 into the main storage unit 15, and executes the functions written in the parts 21 to 23 as programs.

In FIG. 2A, the document preparation support apparatus 3 is configured independently. However, as shown in FIG. 2B, the document preparation support apparatus 3 (in this case, as a server) may be configured to be connected to one or more terminal devices 5 via a network 4. This allows a plurality of users to prepare the response document 2 (see FIG. 1B) together.

### <Rule Group Database>

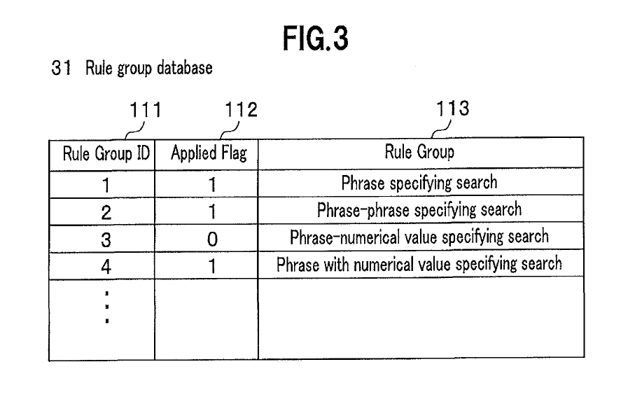

Next is described the rule group database 31 with reference to FIG. 3.

The rule group database 31 stores therein, in association with a rule group ID stored in a rule group ID column 111; an applied flag in an applied flag column 112; and a rule group in a rule group column 113.

A rule group ID in the rule group ID column 111 is an identifier for uniquely identifying a rule group. The rule group used herein is a group to which a rule belongs.

A rule used herein is a search key used when a critical passage is extracted from the RFP 1 (see FIG. 1A). The rule belongs to any of a plurality of rule groups divided according to categories.

An applied flag in the applied flag column 112 is information on whether or not a rule group to which a search key used when a critical passage is extracted from the RFP 1 is selected by a user. The applied flag herein is either “1” indicating that the rule group is selected by the user or “0” indicating that the rule group is not selected by the user.

A rule group shown in the rule group column 113 is a name of the rule group.

Four examples of the rule group are shown herein, that is, a “phrase specifying search”, a “phrase-phrase specifying search”, a “phrase-numerical value specifying search”, and a “phrase with numerical value specifying search”. However, any other rule group may be present.

### <Phrase Specifying Search Rule Database>

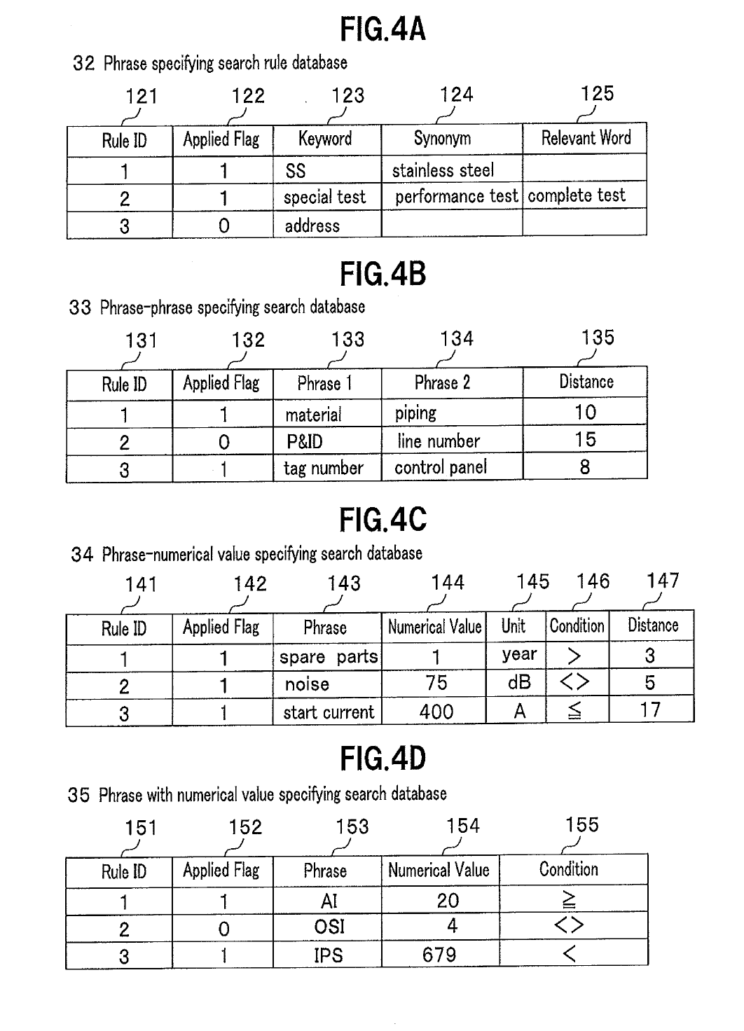

Next is described a phrase specifying search rule database 32 with reference to FIG. 4A.

The phrase specifying search rule database 32 stores therein, in association with a rule ID stored in a rule ID column 121: an applied flag in an applied flag column 122; a keyword in a keyword column 123; a synonym in a synonym column 124; and a relevant word in a relevant word column 125.

A rule ID in the rule ID column 121 is an identifier for uniquely identifying a rule group. The rule group used herein is a group to which a rule belongs. Respective rules correspond to respective records (rows) in the phrase specifying search rule database 32.

An applied flag in the applied flag column 122 is information on whether or not a rule as a search key used when a critical passage is extracted from the RFP 1 is selected by a user. The applied flag herein is either “1” indicating that the rule is selected by the user or “0” indicating that the rule is not selected by the user.

A keyword in the keyword column 123 is used as a search key.

A synonym in the synonym column 124 is used as a search key and has a meaning similar to a corresponding keyword.

A relevant word in the relevant word column 125 is used as a search key and has a meaning relevant to a corresponding keyword.

The synonym column 124 and the relevant word column 125 may or may not be blank.

In extracting a critical passage, a keyword, a synonym, and a relevant word stored in a record of the phrase specifying search rule database 32 are always combined and are used as one search key.

For example, a record on the second row of the phrase specifying search rule database 32 has the keyword of “special test”, the synonym of “performance test”, and the relevant word of “complete test”. This means that a critical passage is searched from the RFP 1 using a search condition of ““special test” or “performance test” or “complete test””.

A plurality of rules may be used as a search key. For example, the applied flag column 122 of FIG. 4A has “1” on the first and second rows and “0” on the third row. This means that a critical passage is extracted from the RFP 1 using a search condition of [[“SS” or “stainless steel”] or [“special test” or “performance test” or “complete test”]].

### <Phrase-Phrase Specifying Search Rule Database>

Next is described a phrase-phrase specifying search rule database 33 with reference to FIG. 4B.

The phrase-phrase specifying search rule database 33 stores therein, in association with a rule ID stored in a rule ID column 131: an applied flag in an applied flag column 132; a phrase 1 in a phrase 1 column 133; a phrase 2 in a phrase 2 column 134; and a distance in a distance column 135.

The rule ID in the rule ID column 131 is the same as that of FIG. 4A.

However, as described above, the rule ID used herein uniquely identifies a rule only in the phrase-phrase specifying search rule database 33.

The applied flag in the applied flag column 132 is the same as that of FIG. 4A.

The phrase 1 in the phrase 1 column 133 is used as a search key.

The phrase 2 in the phrase 2 column 134 is also used as a search key.

The distance in the distance column 135 is a distance (in units of “words”) between the phrase 1 and the phrase 2.

In extracting a critical passage, a phrase 1, a phrase 2, and a distance stored in a record of the phrase-phrase specifying search rule database 33 are always combined and are used as one search key.

For example, a record on the first row of the phrase-phrase specifying search rule database 33 has the phrase 1 of “material”, the phrase 2 of “piping”, and the distance of “10”. This means that a critical passage is searched from the RFP 1 using a search condition of [“material” and the “piping” are present at the distance within “10” words].

A plurality of rules may be used as a search key. For example, the applied flag column 132 of FIG. 4B has “1” on the first and third rows and “0” on the second row. This means that a critical passage is extracted from the RFP 1 using a search condition of [[the “material” and “piping” are present at the distance within “10” words] or [“tag number” and “control panel” are present at the distance within “8” words].

The aforementioned describes a case where there are two phrases. However, a configuration is possible in which there are three or more phrases. In that case, the distance is defined as a distance between, for example, the initial phrase and the last (third) phrase.

### <Phrase-Numerical Value Specifying Search Rule Database>

Next is described a phrase-numerical value specifying search rule database 34 with reference to FIG. 4C.

The phrase-numerical value specifying search rule database 34 stores therein, in association with a rule ID stored in a rule ID column 141: an applied flag in an applied flag column 142; and a phrase in a phrase column 143; a numerical value in a numerical value column 144; a unit in a unit column 145; a condition in a condition column 146; and a distance in a distance column 147.

The rule ID in the rule ID column 141 is the same as that of FIG. 4A.

However, as described above, the rule ID used herein uniquely identifies a rule only in the phrase-numerical value specifying search rule database 34.

The applied flag in the applied flag column 142 is the same as that of FIG. 4A.

The phrase in the phrase column 143 is used as a search key, such as “start current”, and is described together with a numerical value (to be described next).

The numerical value in the numerical value column 144 is used as a search key and is described together with a phrase such as “start current”.

The unit in the unit column 145 is a unit of a corresponding numerical value. If the numerical value is simply the number of corresponding phrases, the unit column 145 may be blank.

The condition in the condition column 146 is an applied condition of a corresponding numerical value. For example, The symbol “≧” represents “equal to or more than”; “>”, “more than”; “≦”, “equal to or less than”; “<”, “less than”; “=”, “equal to”; and “< >”, “not equal to”.

The distance in the distance column 147 is a distance (in units of “words”) between a phrase and a numerical value.

In extracting a critical passage, a phrase, a numerical value, a unit a condition, and a distance stored in one record of the phrase-numerical value specifying search rule database 34 are always combined and are used as a single search key.

For example, a record on the third row of the phrase-numerical value specifying search rule database 34 has the phrase of “start current”, the numerical value of “400”, the unit of “A”, the condition of “≦”, and the distance of “17”. This means that a critical passage is searched from the RFP 1 using a search condition of [“start current” and “400 A” are present at a distance within “17” words].

A plurality of phrases and numerical values can be used as a single search key as described above.

<Phrase with Numerical Value Specifying Search Rule Database>

Next is described a phrase with numerical value specifying search rule database 35 with reference to FIG. 4D.

The phrase with numerical value specifying search rule database 35 stores therein, in association with a rule ID stored in a rule ID column 151: an applied flag in an applied flag column 152; a phrase in a phrase column 153; a numerical value in a numerical value column 154; and a condition in a condition column 155.

The rule ID in the rule ID column 151 is the same as that of FIG. 4A.

However, as described above, the rule ID used herein uniquely identifies a rule only in the phrase with numerical value specifying search rule database 35.

The applied flag in the applied flag column 152 is the same as that of FIG. 4A.

The phrase such as “AI” in the phrase column 153 is used as a search key and is described together with a certain numerical value.

The numerical value in the numerical value column 154 is used as a search key and is described together with a phrase such as the “AI”.

The condition in the condition column 155 is an applied condition of a corresponding numerical value. Meanings of “≧” or the like are as described above.

In extracting a critical passage, a phrase, a numerical value, and a condition stored in one record of the phrase with numerical value specifying search rule database 35 are always combined and are used as a single search key.

For example, a record on the first row of the phrase with numerical value specifying search rule database 35 has the phrase of “AI”, the numerical value of “20”, and the condition of “≧”. This means that a critical passage is searched from the RFP 1 with a search condition of [“20” or more numerical values are present immediately after “AI”].

A plurality of rules can be used as a single search key as described above.

The rule databases 32 to 35 may be collectively referred to as “third corresponding information”.

### <Rule-Knowhow Corresponding Information>

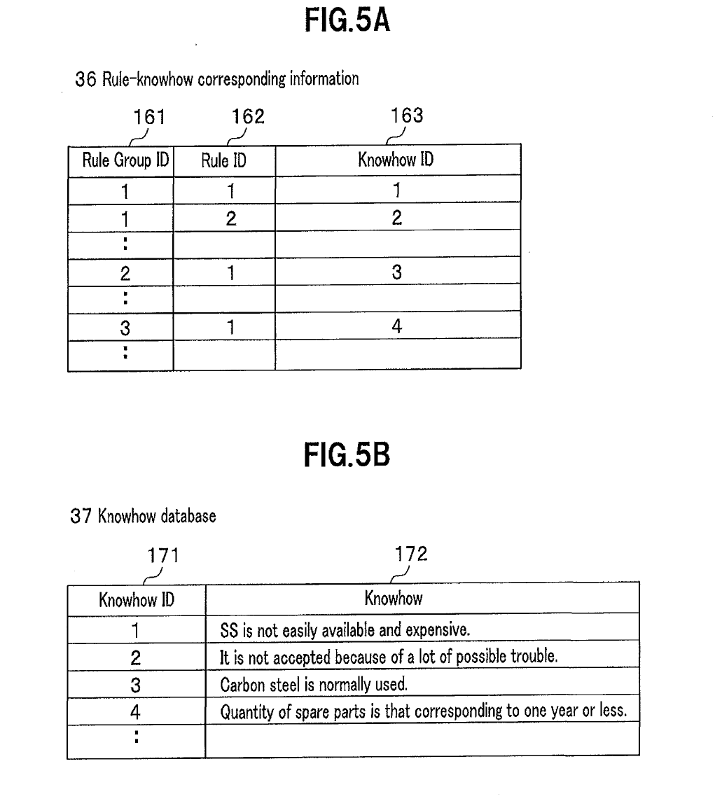

Next is described rule-knowhow corresponding information 36 with reference to FIG. 5A.

The rule-knowhow corresponding information 36 stores therein, in association with a rule group ID stored in a rule group ID column 161: a rule ID in a rule ID column 162; and a knowhow ID in a knowhow ID column 163.

The rule group ID in the rule group ID column 161 is the same as that of FIG. 3.

The rule ID in the rule ID column 162 is the same as those of FIG. 4A to FIG. 4D.

The knowhow ID in the knowhow ID column 163 is an identifier which uniquely identifies a knowhow (to be described in detail hereinafter).

### <Knowhow Database>

Next is described a knowhow database 37 with reference to FIG. 5B.

The knowhow database 37 stores therein, in association with a knowhow ID stored in a knowhow ID column 171, a knowhow in a knowhow column 172.

The knowhow ID in the knowhow ID column 171 is the same as that of FIG. 5A.

The knowhow in the knowhow column 172 is information which is useful for a user when the user recognizes a critical passage obtained from the RFP 1 as a search result. The knowhow does not assume to be outputted to the response document 2, unlike the response described above of the response document 2.

Note that the rule-knowhow corresponding information 36 and the knowhow database 37 can be combined into a single database. In this case, the rule-knowhow corresponding information 36 and the knowhow database 37 may be collectively referred to as “first corresponding information”.

### <Rule-Template Corresponding Information>

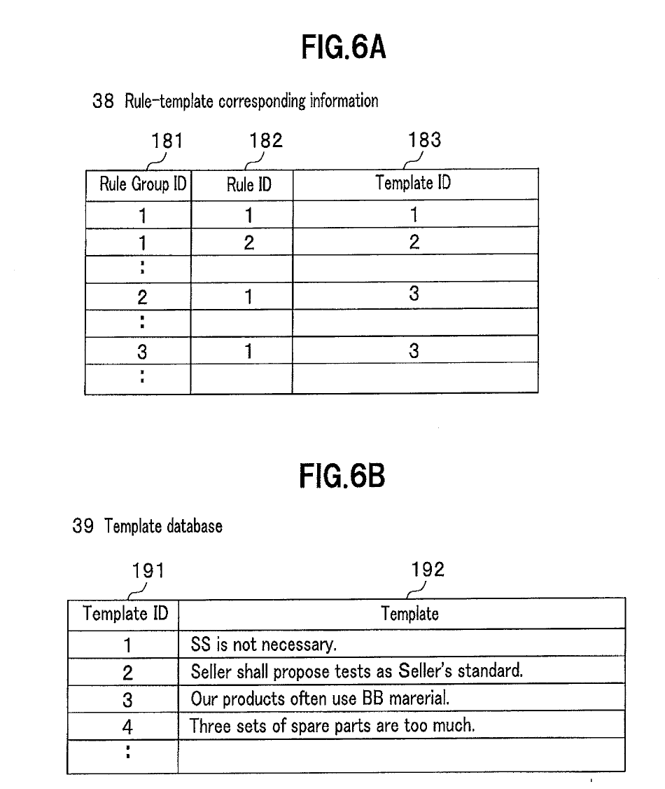

Next is described a rule-template corresponding information 38 with reference to FIG. 6A.

The rule-template corresponding information 38 stores therein, in association with a rule group ID stored in a rule group ID column 181: a rule ID in a rule ID column 182; and a template ID in a template ID column 183.

The rule group ID in the rule group ID column 181 is the same as that of FIG. 3.

The rule ID in the rule ID column 182 is the same as those of FIG. 4A to FIG. 4D.

The template ID in the template ID column 183 is an identifier which uniquely identifies a template (to be described in detail hereinafter).

### <Template Database>

Next is described a template database 39 with reference to FIG. 6B.

The template database 39 stores therein, in association with a template ID stored in a template ID column 191, a template in a template column 192.

The template ID in the template ID column 191 is the same as that of FIG. 6A.

The template in the template column 192 is a template for a response described in the response document 2.

Note that the rule-template corresponding information 38 and the template database 39 can be combined into a single database. In this case, the rule-template corresponding information 38 and the template database 39 may be collectively referred to as “second corresponding information”. The template may also be referred to as a “response example”.

<Relationship between Rule, Knowhow, and Template>

A combination of a rule group ID and a rule ID corresponds to a rule (which is a search key) in a one-to-one relationship. A combination of a rule group ID and a rule ID corresponds to a knowhow in a one-to-n relationship (n=1, 2, 3, . . . ). The combination of a rule group ID and a rule ID corresponds to a template in a one-to-m relationship (m=1, 2, 3, . . . ). That is, one or more knowhows and templates may or may not correspond to a critical passage searched by a single rule. To simplify description, however, a case in which n=m=1 is explained below.

For example, below is described a case in which a search is performed using a search key of [“SS” or “stainless steel”] which is a rule in the first row of the phrase specifying search rule database 32 of FIG. 4A. The rule belongs to a rule group of the “phrase specifying search”. A combination of the rule group ID of “1” and the rule ID of “1” is associated with a knowhow of “SS is not easily available and expensive.” (FIG. 5A, line 1; FIG. 5B, line 1). The combination is also associated with a template of “SS is not necessary.” (FIG. 6A, line 1; FIG. 6B, line 1).

Thus, if a user selects the rule of [“SS” or “stainless steel”] as a search key, the document preparation support apparatus 3 can display the knowhow of “SS is not easily available and expensive.” and the template of “SS is not necessary.” as a search result, in association with the [“SS” or “stainless steel”].

### <Buffer Data>

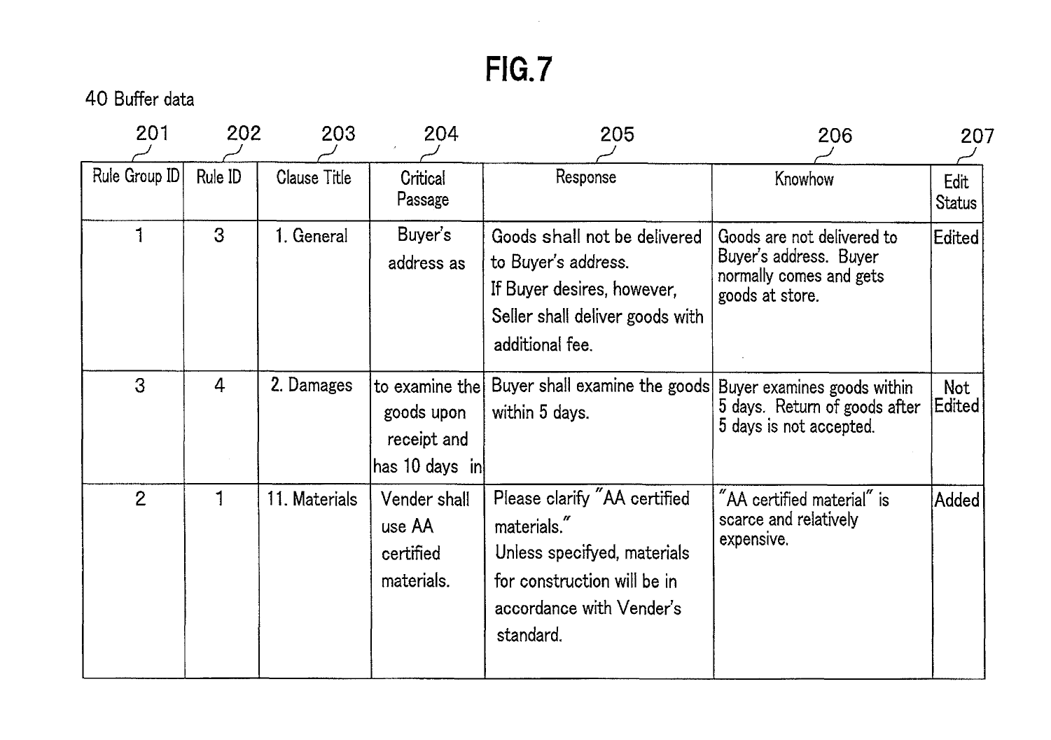

Next is described a buffer data 40 with reference to FIG. 7. The buffer data 40 is, in each processing to be described later, created by each program, temporarily stored in the main storage device 15, and stored in the auxiliary storage device 16 in a prescribed case.

The buffer data 40 stores therein, in association with a rule group ID stored in a rule group ID column 201: a rule ID in a rule ID column 202; a clause title in a clause title column 203; a critical passage in a critical passage column 204; a response in a response column 205; a knowhow in a knowhow column 206; and an edit status in an edit status column 207.

The rule group ID in the rule group ID column 201 is the same as that of FIG. 3.

The rule ID in the rule ID column 202 is the same as those of FIG. 4A to FIG. 4D.

The clause title in the clause title column 203 is a clause title of the RFP 1.

The critical passage in the critical passage column 204 is a passage (a word, a numerical value, or a symbol, or a combination thereof) obtained as a search result if a search in the RFP 1 is performed using a rule as a search key. A user may specify a critical passage regardless of a search result (to be described in detail hereinafter). A critical passage may be stored with a word before and after the passage as a search result so as to help a user easily understand a context of the passage.

A response in the response column 205 is a response of the response document 2. The response may be prepared by editing a template. A template may be a response as it is without being edited. A response may be newly prepared not based on an existing template (to be described in detail hereinafter).

A knowhow in the knowhow column 206 is, as described above, the information which is useful for a user when the user recognizes a critical passage obtained from the RFP 1 as a search result. A knowhow in the buffer data 40 may be prepared by editing a knowhow in the knowhow database 37 or may be newly prepared not based on an existing knowhow (to be described in detail hereinafter).

The edit status in the edit status column 207 is information indicating an edit status of a record. The edit status is represented by any one of “edited”, “not edited”, “unnecessary”, and “added”.

The “edited” represents that a response and/or knowhow of a record is modified from when it was stored in the template database 39 and/or the knowhow database 37, by an edit of a user.

The “not edited” represents that a response and/or knowhow of a record is the same as when it was stored in the template database 39 and/or the knowhow database 37 without any edit of a user.

The “unnecessary” represents that a response and/or knowhow of a record is determined to be unnecessary by a user.

The “added” represents that a response and/or knowhow of a record is newly added by a user (that is, a record corresponding to the response and/or knowhow does not exist in the template database 39 and/or the knowhow database 37).

### <Output Format>

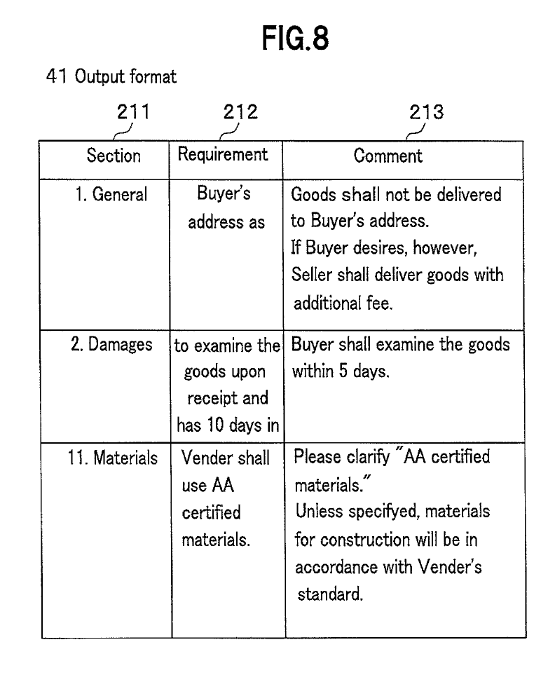

Next is described the output format 41 with reference to FIG. 8. The output format 41 is a data outputted as the response document 2 itself of FIG. 1B and is prepared on a basis of the buffer data 40.

The output format 41 stores therein, in association with a clause title stored in a section column 211: a critical passage in a requirement column 212; a response in a comment column 213.

The clause title in the section column 211 is the same as that of FIG. 7.

The critical passage in the requirement column 212 is the same as that of FIG. 7.

The response in the comment column 213 is the same as that of FIG. 7.

Below are described processings and display windows displayed to a user via the output device 14 as steps of the processings advance.

### <Processings>

The processings include: a critical passage extraction processing; a response document edit/preparation processing; and a knowledge edit/preparation processing, which are performed in this order.

The critical passage extraction processing is a processing in which the critical passage extract part 21 searches the RFP 1 using a rule as a search key and extracts a critical passage.

The response document edit/preparation processing is a processing in which the response document edit/preparation part 22 presents a template and a knowhow associated with the rule to a user and outputs the response document 2.

The knowledge edit/preparation processing is a processing in which the knowledge edit/preparation part 23 stores a knowhow and a template which are prepared by newly creating or by editing existing ones by a user.

Below are described three cases a) to c) of the response document edit/preparation processing in which: a) a user's selection of any of critical passages as search results is received; b) a user's selection of a passage to be newly taken as a critical passage from the RFP 1 is received; and c) a user's selection of neither a) nor b) is received.

After the response document edit/preparation processing is performed, at least one of a) to c) is selectively performed or two of a) to c) are successively performed.

### <Display Window>

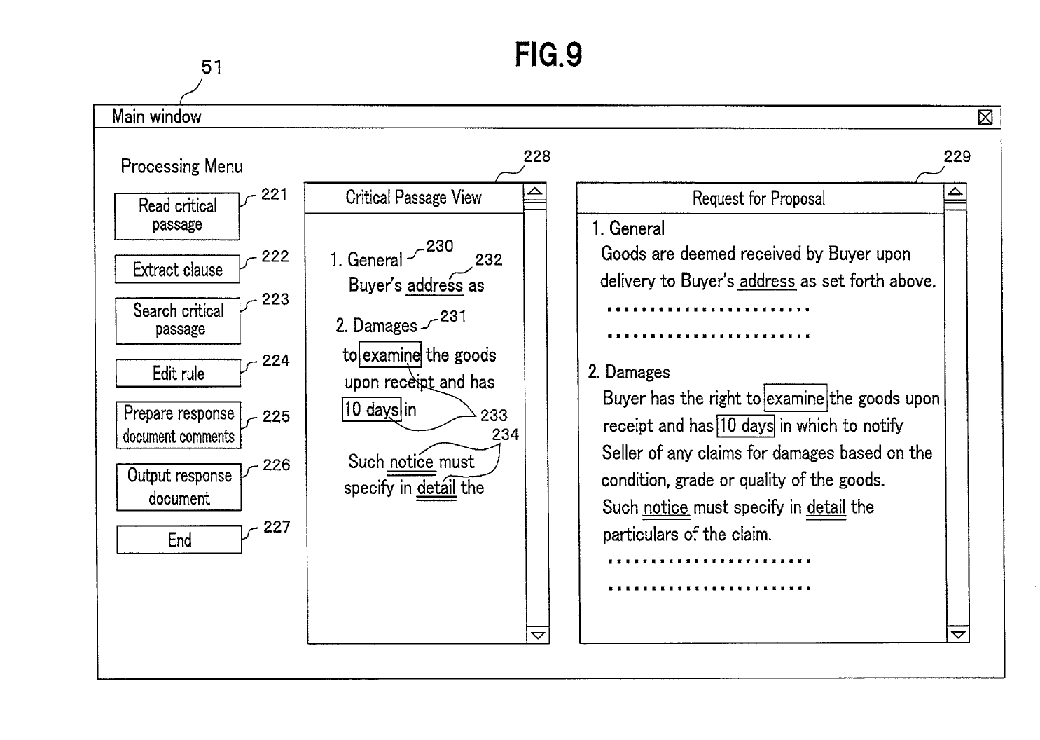

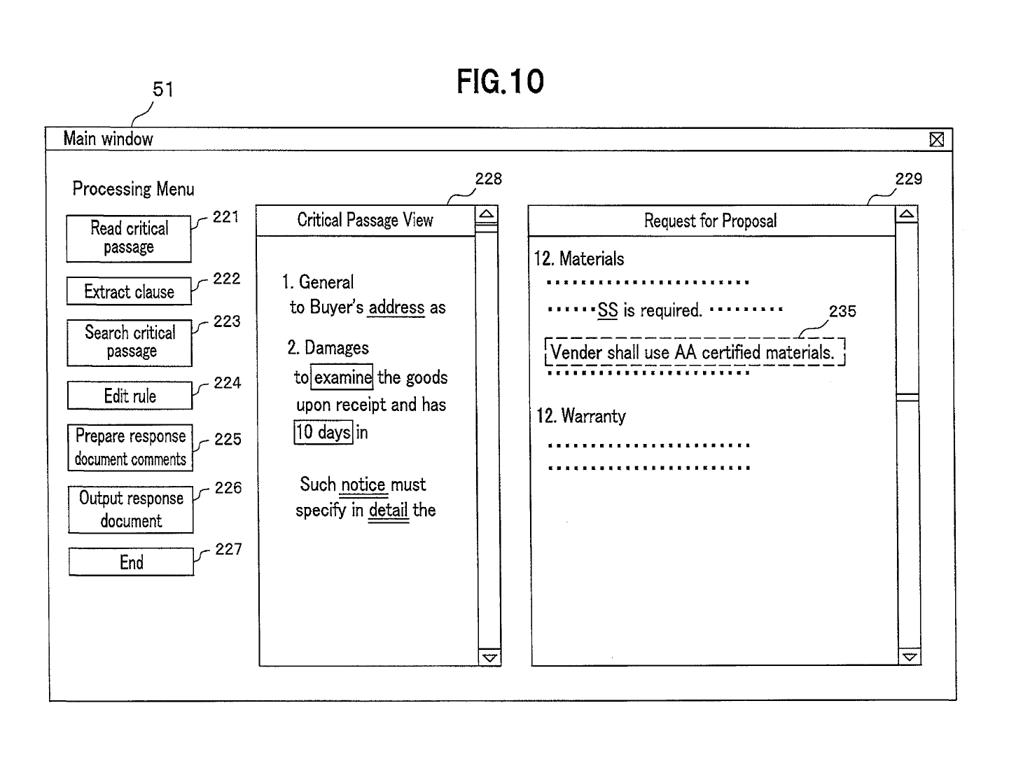

Next is described a main window 51 with reference to FIG. 9 and FIG. 10.

In FIG. 9, a main window 51 appears in the output device 14 when a user starts the document preparation support apparatus 3. The main window 51 includes as a processing menu: a RFP read button 221; a clause extract button 222; a critical passage search button 223; a rule edit button 224; a response document comment preparation button 225; a response document output button 226; and an end button 227. The main window 51 also includes: a critical passage view column 228; and a RFP column 229.

The critical passage view column 228 displays critical passages 232 to 234 searched using a rule, and clause titles 230, 231 of which clauses contain the critical passages. If there are a plurality of critical passages in one clause, a plurality of critical passages are displayed in association with the one clause title. The critical passages 232 to 234 are highlighted with an underline, a double underline, a boxed frame, or the like. Actually, the critical passages 232 to 234 are results searched using the rule as a search key. The critical passages 232 to 234 are highlighted in different ways because, in this case, rules used as search keys are different.

The RFP column 229 displays the RFP 1. The critical passages are highlighted also in the RFP column 229.

Also in FIG. 10, the main window 51 is shown. Herein, a user selects a passage 235 of “Vender shall use . . . ” in the RFP column 229 (to be described in detail hereinafter).

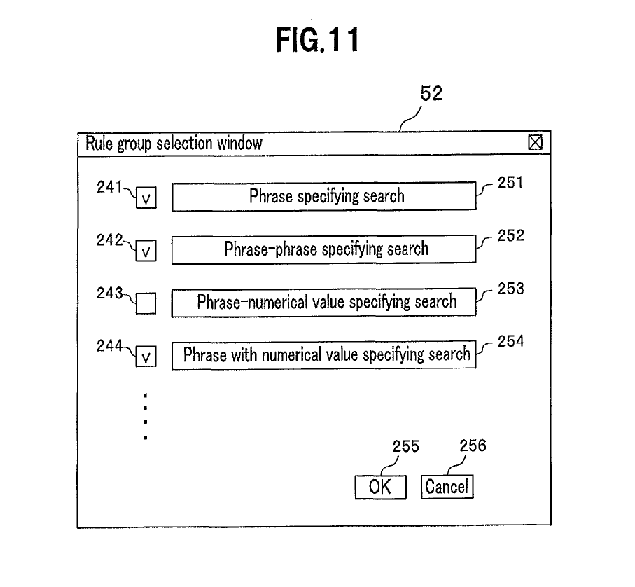

Next is described a rule group selection window 52 with reference to FIG. 11.

A rule group selection window 52 appears if the rule edit button 224 of the main window 51 of FIG. 9 is pressed down. The rule group selection window 52 includes: rule group select buttons 251 to 254; check boxes 241 to 244 associated with the respective rule group select buttons 251 to 254; an OK button 255; and a cancel button 256.

A user selects one or more check boxes 241 to 244 of one or more corresponding rule groups which the user wants to use. If the OK button 255 is pressed down, the selection becomes valid. If the cancel button 256 is then pressed down, the selection is cleared. A configuration is possible in which a result of a previous selection is stored, and, if the cancel button 256 is pressed down, the previous selection result becomes valid.

Note that the rule group select buttons 251 to 254 correspond to the respective rule databases 32 to 35 in a one-to-one relationship.

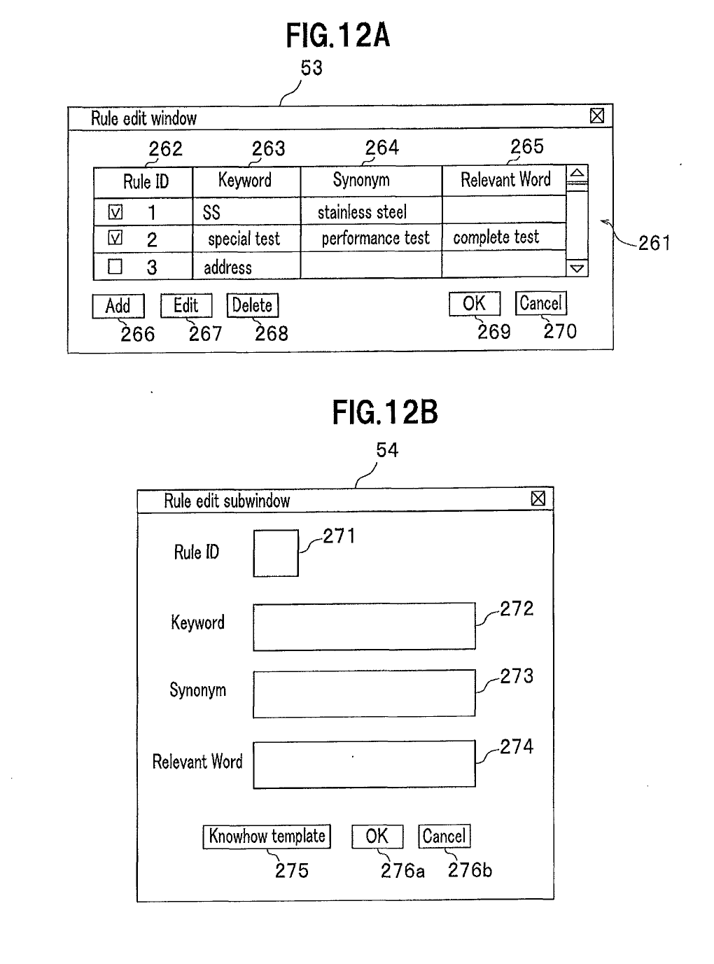

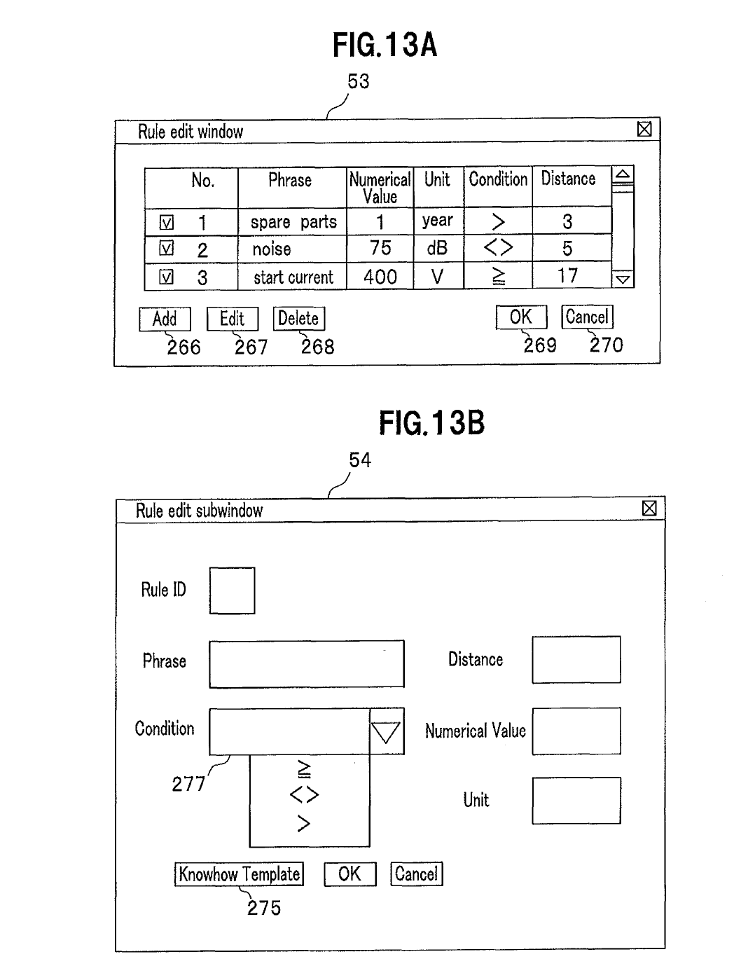

Next are described a rule edit window 53 and a rule edit subwindow 54 with reference to FIGS. 12A and 12B and FIGS. 13A and 13B. FIG. 12A and FIG. 12B show the rule edit window 53 and the rule edit subwindow 54 for the “phrase specifying search”, respectively. FIG. 13A and FIG. 13B show the rule edit window 53 and the rule edit subwindow 54 for the “phrase-numerical value specifying search”, respectively.

Configurations of the rule edit window 53 and the rule edit subwindow 54 are almost similar to each other according to a selected rule group but are different in details. Thus, the terms of a rule edit window or subwindow are commonly used for all rule groups.

The rule edit window 53 of FIG. 12A appears if the “phrase specifying search” button 251 is pressed down from among the rule group select buttons 251 to 254 on the rule group selection window 52 of FIG. 11. The rule edit subwindow 54 of FIG. 12B appears if an add button 266 or an edit button 267 of FIG. 12A is pressed down.

The rule edit window 53 includes: a list 261; the add button 266; the edit button 267; a delete button 268; an OK button 269; and a cancel button 270.

The list 261 is similar to the phrase specifying search rule database 32 (FIG. 4A). A rule ID column 262 displays a rule ID and a check box. A checkmark in the check box corresponds to “1” of the applied flag of FIG. 4A. No checkmark in the check box corresponds to the applied flag of “0”.

If the user places a checkmark in a check box of the rule ID column 262 in the list 261, a corresponding record becomes valid as a search key.

Then, if the user pressed down the add button 266, the rule edit subwindow 54 of FIG. 12B appears. At this time, a keyword column 272, a synonym column 273, and a relevant word column 274 on the rule edit subwindow 54 are blank. A rule ID column 271 shows “a maximum value of the rule ID+1”.

The user can enter a keyword, a synonym, and a relevant word in the keyword column 272, the synonym column 273, and the relevant word column 274, respectively, shown on the rule edit subwindow 54.

Upon a press down of the OK button 276a on the rule edit subwindow 54 by the user, the entered data is added to the list 261 as a new record. If the user presses down the cancel button 276b on the rule edit subwindow 54, the entered data is cleared.

Alternatively, if the user specifies a record in the list 261 (for example, by pointing a cursor to any part of the record) and presses down the edit button 267, the rule edit subwindow 54 of FIG. 12B appears. This time, a rule ID, a keyword, a synonym, and a relevant word each corresponding to the specified record are shown in the rule ID column 271, the keyword column 272, the synonym column 273, and the relevant word column 274, respectively.

The user can edit the keyword, the synonym, and the relevant word displayed on the rule edit subwindow 54.

Upon a press down of the OK button 275 on the rule edit subwindow 54 by the user, the edited data is overwritten on the specified record in the list 261. If the user presses down the cancel button 276b on the rule edit subwindow 54, the edited data is cleared.

Further alternatively, if the user specifies a record in the list 261 and presses down the delete button 268, the specified record is deleted from the list 261.

Finally, after the above described addition, edit, or deletion of the record is completed, if the user presses down the OK button 269 on the rule edit window 53, all records in the list 261 are overwritten and stored in the phrase specifying search rule database 32. If the cancel button 270 on the rule edit window 53 is pressed down, the edited data is cleared.

The rule edit window 53 of FIG. 13A appears if the rule group select button 253 (FIG. 11) for the “phrase-numerical value specifying search” is pressed down.

The rule edit subwindow 54 of FIG. 13B appears if the add button 266 or the edit button 267 of FIG. 13A is pressed down. The window 53 and the subwindow 54 of FIG. 13A and FIG. 13B are similar to those of FIG. 12A and FIG. 12B except that, those 53, 54 of FIG. 13A and FIG. 13B have six columns and that the rule edit subwindow 54 has a condition column 277 in which the symbol such as “≧” can be chosen from a pull-down menu.

As described above, according to a press-down of the rule group select buttons 251 to 254 on the rule group selection window 52, respective rule edit windows 53 and rule edit subwindows 54 of which configurations are somewhat different one another appear. However, descriptions of the windows 53 and the subwindow 54 of the other rule groups are omitted herefrom. A knowhow template button 275 on the rule edit subwindow 54 is to be described later.

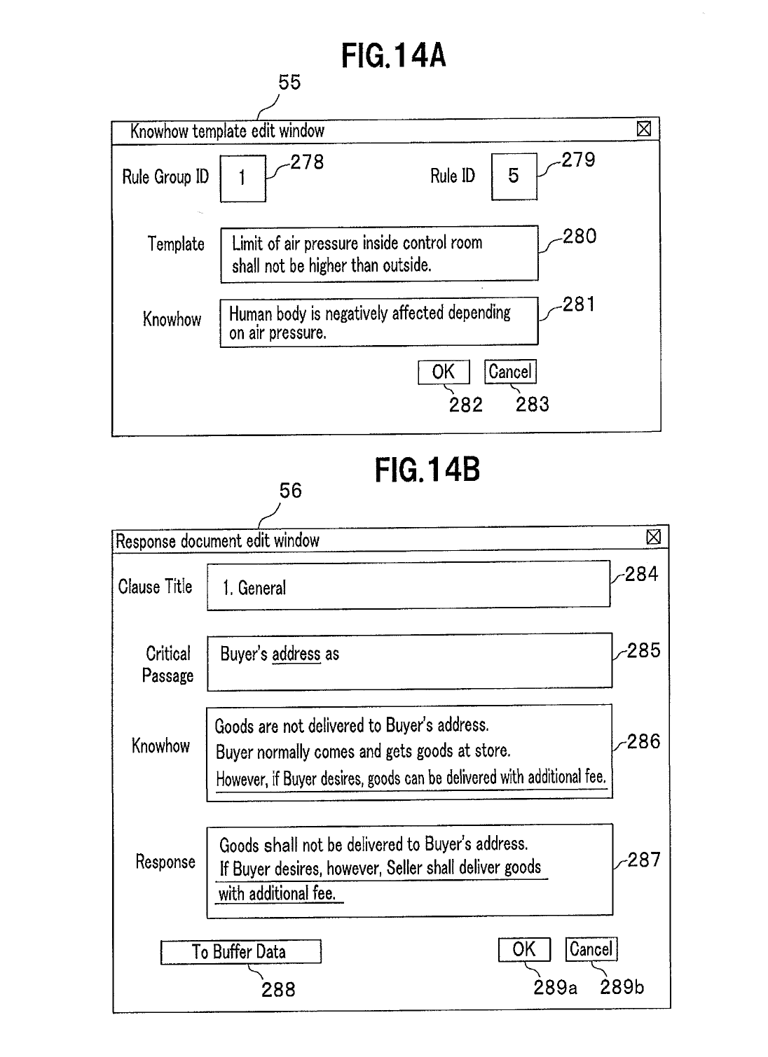

Next is described a knowhow template edit window 55 with reference to FIG. 14A.

The knowhow template edit window 55 is used for editing a knowhow and a template. The knowhow template edit window 55 appears upon a press down of the knowhow template button 275 on the rule edit subwindow 54 (FIG. 12B and FIG. 13B).

A rule group ID column 278 shows a rule group ID of a rule group displayed on the rule edit window 53 at that time. A rule ID column 279 shows a rule ID displayed on the rule edit subwindow 53 at that time or “a maximum value of the rule ID+1”.

A template column 280 shows a template (FIG. 6B) having a template ID which is identified by a combination of a rule group ID and a rule ID.

A knowhow column 281 shows a knowhow (FIG. 5B) having a knowhow ID which is identified by a combination of a rule group ID and a rule ID. The user can edit an existing template and an existing knowhow in the template column 280 and the knowhow column 281, respectively.

However, if the add button 266 on the rule edit window 53 is pressed down, and then, the knowhow template button 275 on the rule edit subwindow 54 is pressed down, the template column 280 and the knowhow column 281 are blank. This is because no corresponding knowhow and template exists yet. The user can herein enter a new template and knowhow in the template column 280 and the knowhow column 281, respectively.

Upon a press down of an OK button 282, the inputted template is stored in the template database 39 (FIG. 6B) in association with the rule group ID and the rule ID. The inputted knowhow is stored in the knowhow database 37 (FIG. 5B) in association with the rule group ID and the rule ID.

An input or an edit of either the template or the knowhow may be omitted.

Next is described a response document edit window 56 with reference to FIG. 14B. The response document edit window 56 is used for preparing the response document 2 by editing a knowhow and a template. The response document edit window 56 appears when a critical passage is selected in the critical passage view column 228 on the main window 51 (FIG. 9), and the response document comment preparation button 225 is then pressed down.

A clause title column 284 shows a clause title of a clause which contains the selected critical passage. A critical passage column 285 shows the selected critical passage.

A knowhow column 286 shows a knowhow having a knowhow ID which is associated with a combination of a rule group ID and a rule ID for identifying a rule as a search key when the critical passage is extracted.

A response column 287 shows a template having a template ID which is associated with a combination of a rule group ID and a rule ID for identifying a rule as a search key when the critical passage is extracted.

Referring to the knowhow column 286 of FIG. 14B, an underlined portion is added to a knowhow which has been previously stored in the knowhow database 37. The underlined portion is a data entered in the knowhow column 286 by the user.

Similarly, referring to the response column 287, an underlined portion is added to a template which has been previously stored in the template database 39. The underlined portion is a data entered in the response column 287 by the user.

Upon a press down of a “to buffer data” button 288, information on the response document edit window 56 is stored as a record in the buffer data 40 (FIG. 7). That is, a clause title, a critical passage, a knowhow (including the added underlined portion), a knowhow (including the added underlined portion), a template (including the added underlined portion), a rule group ID, and a rule ID, the latter two for identifying a rule as a search key when the critical passage has been extracted, are stored in the clause title column 203, the critical passage column 204, the knowhow column 206, the response column 205, the rule group ID column 201, and the rule ID column 202 of the buffer data 40, respectively.

Upon a press down of an OK button 289a, the buffer data 40 is stored in the auxiliary storage device 16. Upon a press down of a cancel button 289b, the buffer data 40 returns to its original state without reflecting the edit and is stored in the auxiliary storage device 16.

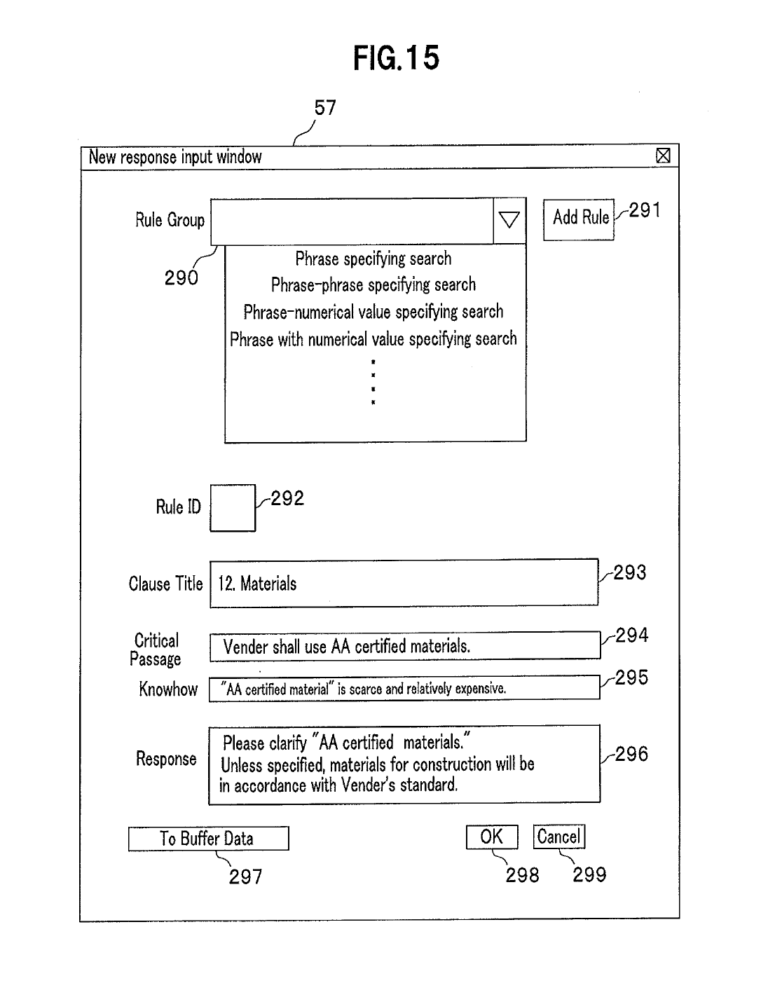

Next is described a new response input window 57 with reference to FIG. 15. The new response input window 57 is used when a user finds a passage to be newly taken as a critical passage in the RFP column 229 (FIG. 10) on the main window 51. The user creates a new rule (that is, creates in turn a search key for extracting the critical passage) and creates a knowhow and a template in association with the newly-created rule on the new response input window 57. The new response input window 57 appears if the passage 235 required to be a critical passage is selected in the RFP column 229 on the main window 51, and the response document comment preparation button 225 is pressed down.

When the new response input window 57 appears, a critical passage column 294 (FIG. 15) displays a passage selected by the user from the RFP 1 (that is, the passage 235 of FIG. 10). A clause title column 293 shows a clause title of a clause containing the selected passage. A rule group column 290, a rule ID column 292, a knowhow column 295, and a response column 296 are blank.

The user selects one of the rule groups in the rule group column 290 and presses down an add rule button 291, thus appearing the rule edit window 53.

After that, as described above, a new rule is added.

The rule ID column 292 of FIG. 15 then shows a “maximum value of the rule ID+1”.

The user inputs a knowhow in the knowhow column 295 and a response in the response column 296.

Upon a press down of a “to buffer data” button 297, information on the new response input window 57 is stored as a record in the buffer data 40 (FIG. 7). That is, a clause title, a critical passage, a knowhow, a response, a rule group ID of the selected rule group, and a “maximum value of the rule ID+1” are stored in the clause title column 203, the critical passage column 204, the knowhow column 206, the response column 205, the rule group ID column 201, and the rule ID column 202 of the buffer data 40, respectively.

Upon a press down of an OK button 298, the buffer data 40 is stored in the auxiliary storage device 16. Upon a press down of a cancel button 299, the buffer data 40 returns to its original state without reflecting a result of the input and is stored in the auxiliary storage device 16.

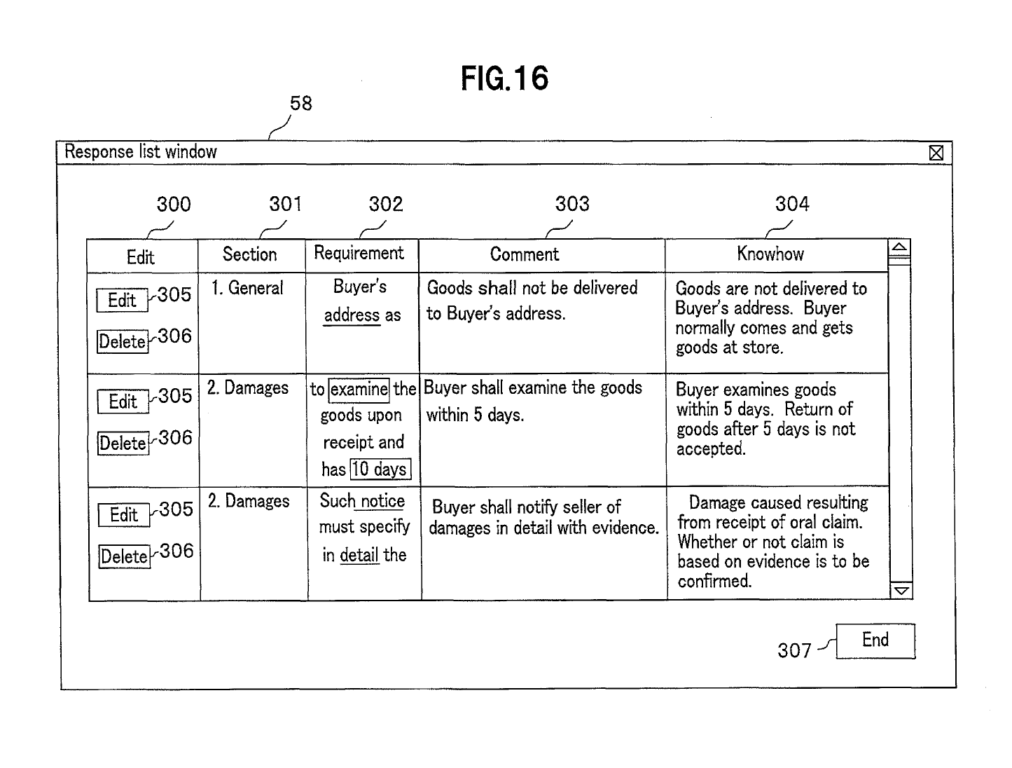

Next is described a response list window 58 with reference to FIG. 16.

The response list window 58 is used when the user looks at a list of a template and a knowhow associated with a critical passage, determines whether or not a response to the critical passage is necessary, and edits the response and the knowhow if necessary. The response list window 58 appears if the response document comment preparation button 225 on the main window 51 (FIG. 9) is pressed down without any critical passage being selected.

The response list window 58 is displayed based on part of the buffer data 40. A section column 301, a requirement column 302, a comment column 303, and a knowhow column 304 of the response list window 58 correspond to the clause title column 203, the critical passage column 204, the response column 205, and the knowhow column 206 of the buffer data 40, respectively. An edit column 300 includes an edit button 305 and a delete button 306 for each record.

When the response list window 58 appears, all of the columns 301 to 304 have already been filled.

Upon a press down of the edit button 305, the response document edit window 56 (FIG. 14B) appears. The response document edit window 56 displays contents of a corresponding record, thus allowing the user to edit a response and a knowhow. The edited response and knowhow are shown in the comment column 303 and the knowhow column 304 on the response list window 58, respectively.

If the delete button 306 is pressed down, a corresponding record is deleted from the response list window 58. Another configuration is possible in which, upon a press down of the delete button 306, the edit column 300 of the corresponding record displays “Already Deleted”, and, upon a press down of a restore button (not shown), the “Already Deleted” record is restored.

If an end button 307 is pressed down, the response list window 58 is closed.

### <Critical Passage Extraction Processing>

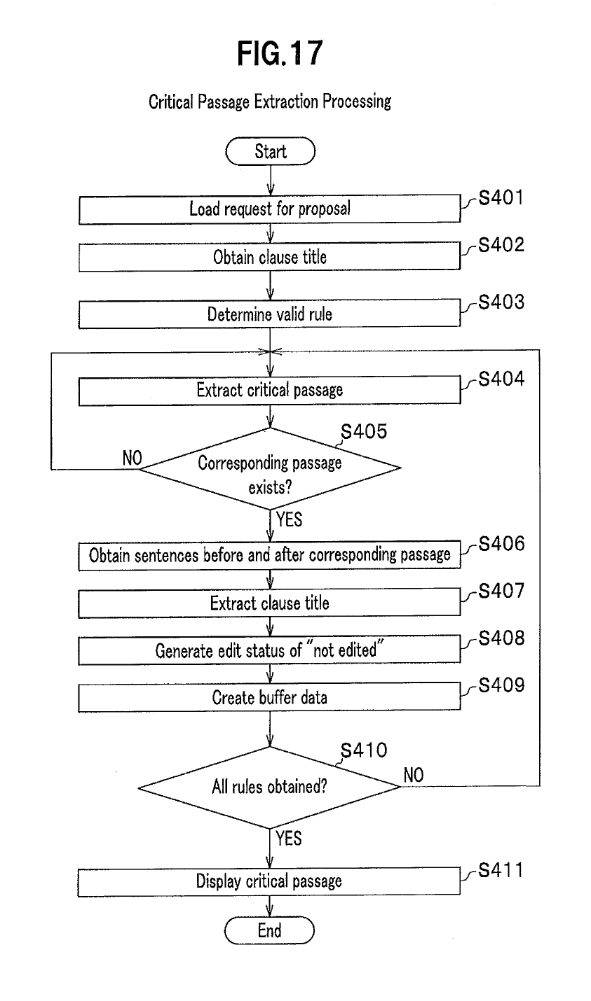

Next is described the critical passage extraction processing with reference to FIG. 17.

Before starting steps of the processing, it is assumed that the main window 51 (FIG. 9) appears in the output device 14.

In step S401, the critical passage extract part 21 loads the RFP 1 in response to a press down of the RFP read button 221.

More specifically, the critical passage extract part 21 loads the RFP 1 via the input device 12 if the RFP 1 is in text format. If the RFP 1 is not in text format, for example, if it is printed on a paper medium, the RFP 1 is loaded via the read device 13 such as a scanner. The read device 13 is herein assumed to convert an image data into a text data. One or more RFPs 1 may be loaded. However, description herein is made assuming that one RFP 1 is loaded.

In step S402, the critical passage extract part 21 obtains a clause title in response to a press down of the clause extract button 222.

More specifically, the critical passage extract part 21 obtains all clause titles 311 (FIG. 1A) from the RFP 1.

In step S403, the critical passage extract part 21 determines a rule which is valid.

More specifically, firstly, the critical passage extract part 21 displays the rule group selection window 52 (FIG. 11) in response to a press down of the rule edit button 224; receives an input of a checkmark in one or more check boxes 241 to 244; receives a press down of the OK button 255; and displays the rule edit window 53 (FIG. 12A, for example) in response to a press down of the rule group select buttons 251 to 254. Then, the critical passage extract part 21 loads the rule databases 32 to 35 (FIG. 4A to FIG. 4D) corresponding to the selected rule group(s) from the auxiliary storage device 16 and displays the loaded data as the list 261 on the rule edit window 53.

The user performs an addition, an edit, or a deletion of a record as necessary while looking at the list 261; places a checkmark in the rule ID column 262 of a record (a valid record) indicating a rule (a valid rule) which the user wants to make valid as a search key; and presses down the OK button 269.

Secondly, the critical passage extract part 21 sets, at “1”, an applied flag of a record in the rule group database 31 (FIG. 3) corresponding to a rule group with a checkmark placed in the check boxes 241 to 244 (FIG. 11) and also sets, at “0”, an applied flag of the other records.

Thirdly, the critical passage extract part 21 stores the record shown in the list 261 as a record in the rule databases 32 to 35 (FIG. 4A to FIG. 4D). Thus, “1” is set in an applied flag column of a valid record, and “0” is set in an applied flag column of an invalid record.

In step S404, the critical passage extract part 21 extracts a critical passage in response to a press down of the critical passage search button 223.

More specifically, firstly, the critical passage extract part 21 obtains any one of valid records stored in step S403 and not yet subjected to the processing in all of the rule databases 32 to 35 and takes the obtained record as a search key. However, if the applied flag of the rule group database 31 for the rule databases 32 to 35 is “0”, the corresponding rule databases 32 to 35 are excluded from the processing. Secondly, the critical passage extract part 21 searches the RFP 1 loaded in step S401 using the search key and obtains a corresponding passage. Note that the corresponding passage may not exist.

In step S405, the critical passage extract part 21 determines whether or not a corresponding passage exists.

More specifically, if the critical passage extract part 21 has been able to obtain a corresponding passage in step S404 (if “Yes” in step S405), the processing advances to step S406. And, if not (if “No” in step S405), the processing returns to step S404.

In step S406, the critical passage extract part 21 obtains terms before and after the corresponding passage obtained in step S404.

More specifically, a range to be obtained as the terms before and after the passage can be previously set, for example, “three words before and after the corresponding passage”, “the other words in a sentence containing the corresponding passage”, and “the other words in a sentence containing the corresponding passage and one sentence before and after the sentence”.

In step S407, the critical passage extract part 21 extracts a clause title.

More specifically, the critical passage extract part 21 extracts a clause title of a clause containing the corresponding passage in step S404 from among the clause titles obtained in step S402.

In step S408, the critical passage extract part 21 generates an edit status of “not edited”.

In step S409, the critical passage extract part 21 creates the buffer data 40.

More specifically, firstly, the critical passage extract part 21 creates a new record of the buffer data 40.

Secondly, the critical passage extract part 21 stores a rule group ID and a rule ID of the valid record obtained in step S404, in the rule group ID column 201 and the rule ID column 202, respectively; stores the clause title extracted in step S407, in the clause title column 203; stores the corresponding passage in step S404 together with the terms before and after the corresponding passage obtained in step S406, in the critical passage column 204; and stores the “not edited” created in step S408, in the edit status column 207.

Note that the response column 205 and the knowhow column 206 of the record in the buffer data 40 remain blank.

In step S410, the critical passage extract part 21 determines whether or not all rules have been obtained.

More specifically, the critical passage extract part 21 determines that there is no valid record not yet subjected to the processing in the records stored in step S403 in all of the rule databases 32 to 35 (if “Yes” in step S410), the processing advances to step S411. And, if not (if “No” in step S410), the processing returns to step S404.

In step S411, the critical passage extract part 21 displays a critical passage.

More specifically, firstly, the critical passage extract part 21 displays the entire RFP 1 loaded in step S401, in the RFP column 229 on the main window 51 (FIG. 9). At this time, the corresponding passage in step S404 is highlighted.

Secondly, the critical passage extract part 21 displays the corresponding passage in step S404 together with the terms before and after the corresponding passage obtained in step S406, in the critical passage view column 228 on the main window 51; and also displays the clause title extracted in step S407. At this time, the displayed corresponding passage in step S404 is highlighted.

The critical passage extraction processing then terminates.

### <Response Document Edit/Preparation Processing A>

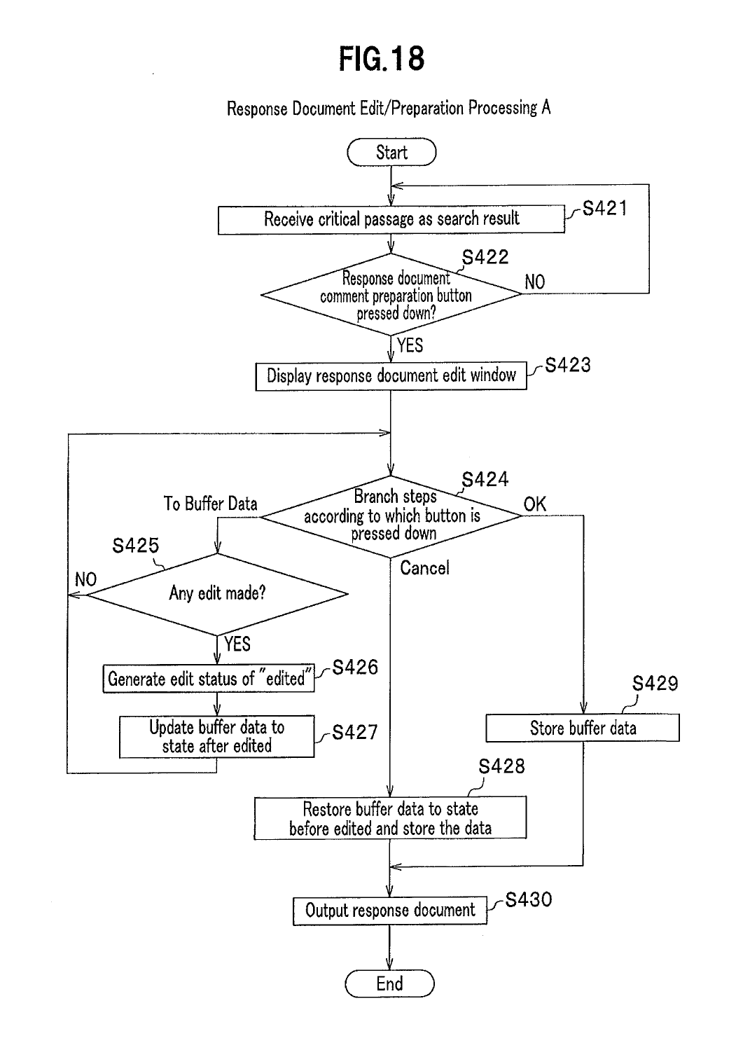

Next is described a response document edit/preparation processing A with reference to FIG. 18.

In step S421, the response document edit/preparation part 22 receives a critical passage as a search result.

More specifically, the response document edit/preparation part 22 receives a user's selection of a critical passage (a highlighted portion) displayed in the critical passage view column 228 (FIG. 9) on the main window 51.

In step S422, the response document edit/preparation part 22 determines whether or not the response document comment preparation button 225 is pressed down.

More specifically, the response document edit/preparation part 22 receives a press down of the response document comment preparation button 225 by the user (if “Yes” in step S422), the processing advances to step S423. And, if not (if “No” in step S422), the processing returns to step S421.

In step S423, the response document edit/preparation part 22 displays a response document edit window 56 (FIG. 14B).

More specifically, firstly, the response document edit/preparation part 22 displays the response document edit window 56 whose columns are all blank.

Secondly, the response document edit/preparation part 22 searches the rule-knowhow corresponding information 36 using a rule group ID and a rule ID for identifying a valid rule when the critical passage selected in step S421 is extracted, as search keys; obtains a knowhow ID of a corresponding record; searches the knowhow database 37 using the knowhow ID as a search key; obtains a knowhow of a corresponding record; and displays the obtained knowhow in the knowhow column 286.

Thirdly, the response document edit/preparation part 22 searches the rule-template corresponding information 38 using the rule group ID and the rule ID for identifying a valid rule when the critical passage selected in step S421 is extracted, as a search key; obtains a template ID of a corresponding record; searches the template database 39 using the template ID as a search key; obtains a template of the corresponding record; and displays the obtained template in the response column 287.

Fourthly, the response document edit/preparation part 22 displays the selected critical passage together with the terms before and after the selected critical passage, in the critical passage column 285; and displays a clause title of a clause containing the selected critical passage, in the clause title column 284.

Herein, the user can make an edit in the knowhow column 286 and the response column 287.

In step S424, the response document edit/preparation part 22 branches steps according to which button is pressed down.

More specifically, if “To buffer data” button 287 is pressed down (if “to buffer data” in step S424), the response document edit/preparation part 22 branches the processing to step S425. If the cancel button 289 is pressed down (if “Cancel” in step S424), the response document edit/preparation part 22 branches the processing to step S428. If the OK button 288 is pressed down (if “OK” in step S424), the response document edit/preparation part 22 branches the processing to step S429.

In step S425, the response document edit/preparation part 22 determines whether or not any edit has been made.

More specifically, if the user has edited at least one of the knowhow column 286 and the response column 287 (if “Yes” in step S425), the response document edit/preparation part 22 branches the processing to step S426. And, if not (if “No” in step S425), the processing returns to step S424.

In step S426, the response document edit/preparation part 22 generates the edit status of “edited”.

In step S427, the response document edit/preparation part 22 updates the buffer data 40 to a state after edited.

More specifically, the response document edit/preparation part 22 stores a knowhow and a response both after edited by the user, in the knowhow column 206 and in the response column 205, respectively, of the record in the buffer data 40 created in step S409 (Note that the response column 205 and the knowhow column 206 remain blank).

In step S428, the response document edit/preparation part 22 restores the buffer data 40 to a state before edited by the user and stores the restored buffer data 40 in the auxiliary storage device 16.

In step S429, the response document edit/preparation part 22 stores the buffer data 40 in the auxiliary storage device 16.

A series of step S421 to step S428 (or 5429) are repeated each time the user selects a new critical passage.

In step S430, the response document edit/preparation part 22 outputs the response document 2 in response to a press down of the response document output button 226 (FIG. 9).

More specifically, the response document edit/preparation part 22 outputs the clause title column 203, the critical passage column 204, and the response column 205 of the buffer data 40 as the output format 41. At this time, the clause title, the critical passage (including terms before and after the passage), and the response are once stored in the section column 211, the requirement column 212, and the comment column 213 of the output format 41, respectively, and are then outputted.

Step S430 can be omitted according to an instruction by the user. This is because, if response document edit/preparation processings B and C to be described later are performed, it is convenient to output the response document 2 not at this time but after the processings B and C are performed (ditto with steps S451 and S469 to be described later).

The response document edit/preparation processing A then terminates.

### <Response Document Edit/Preparation Processing B>

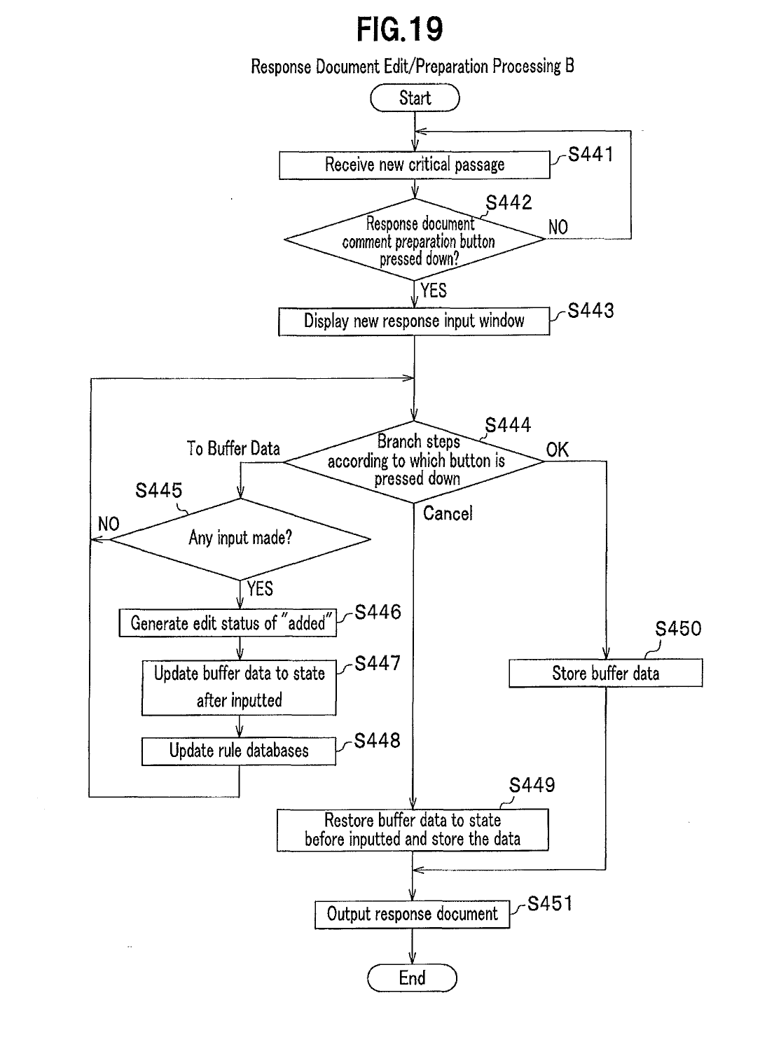

Next is described the response document edit/preparation processing B with reference to FIG. 19.

In step S441, the response document edit/preparation part 22 receives a new critical passage.

More specifically, the response document edit/preparation part 22 receives a user's selection of a portion of the RFP 1 displayed in the RFP column 229 (FIG. 10) on the main window 51, as a critical passage. For example, in FIG. 10, a portion of “Vender shall use AA certified materials.” 235 is selected.

In step S442, the response document edit/preparation part 22 determines whether or not the response document comment preparation button 225 is pressed down.

More specifically, if the response document edit/preparation part 22 determines that the user presses down the response document comment preparation button 225 (if “Yes” in step S442), the processing advances to step S443. And, if not (if “No” in step S442), the processing returns to step S441.

In step S443, the response document edit/preparation part 22 displays a new response input window 57 (FIG. 15).

The response document edit/preparation part 22 displays the critical passage (that is, the passage 235) selected in step S441, in the critical passage column 294 and then displays a clause title of a clause containing the critical passage, in the clause title column 293. For example, in FIG. 15, the critical passage column 294 shows “Vender shall use AA certified materials.”, and the clause title column 293 shows “12. Materials”. The other columns remain blank.

The user then selects a rule group in the rule group column 290 and presses down the add rule button 291, which makes the rule edit window 53 and the rule edit subwindow 54 (FIG. 12 and FIG. 13) displayed. The user can set a search rule for extracting a critical passage selected in step S441, on those windows 53, 54. Further, the user can make new inputs in the knowhow column 295 and the response column 296 on the new response input window 57 of FIG. 15.

In step S444, the response document edit/preparation part 22 branches steps of the processing according to which button is pressed down.

More specifically, if the response document edit/preparation part 22 determines that the “to buffer data” button 297 is pressed down (if “To buffer data” in step S444), the processing advances to step S445; if the cancel button 299 (if “Cancel” in step S444), to step S449; and, if the OK button 298 (if “OK” in step S444), to step S450.

In step S445, the response document edit/preparation part 22 determines whether or not any input has been made.

More specifically, if the response document edit/preparation part 22 determines that the user has made an input at least one of the knowhow column 295 and the response column 296 (if “Yes” in step S445), the processing advances to step S446. And, if not (if “No” in step S445), the processing returns to step S444.

In step S446, the response document edit/preparation part 22 generates an edit status of “added”.

In step S447, the response document edit/preparation part 22 updates the buffer data 40 (FIG. 7) to a state after the input has been made.

More specifically, firstly, the response document edit/preparation part 22 creates a new record in the buffer data 40.

Secondly, the response document edit/preparation part 22 stores the knowhow and the template inputted by the user in the knowhow column 295 and the response column 296 on the new response input window 57 (FIG. 15), in the knowhow column 206 and the response column 205 of the newly created record.

Thirdly, the response document edit/preparation part 22 stores a rule ID of the rule group selected by the user in the rule group column 290, in the rule group ID column 201 and also stores a “maximum value of the rule ID+1” in the rule ID column 202.

Fourthly, the response document edit/preparation part 22 stores the critical passage received in step S441 together with the terms before and after the passage, in the critical passage column 204; a clause of a clause title containing the critical passage, in the clause title column 203; and the “added” in the edit status column 207.

In step S448, the response document edit/preparation part 22 updates the rule databases 32 to 35.

For example, assume that the user selects the “phrase specifying search” in the rule group column 290 on the new response input window 57 of FIG. 15 and inputs: “AA” in the keyword column 272; “Authorized American” in the synonym column 273; and “Non-authorized American” in the relevant word 274, on the rule edit subwindow 54 of FIG. 12B. Then, if the user presses down the OK button 276a (FIG. 12B) and the OK button 269 (FIG. 12A), the response document edit/preparation part 22 stores the inputted information as a new record in the phrase specifying search rule database 32.

In step S449, the response document edit/preparation part 22 restores the buffer data 40 to a state before the input has been made by the user and stores the restored data in the auxiliary storage device 16.

In step S450, the response document edit/preparation part 22 stores the buffer data 40 in the auxiliary storage device 16.

A series of step S441 to step S449 (or 5450) are repeated each time the user selects a new critical passage.

In step S451, the response document edit/preparation part 22 outputs the response document 2 in response to a press down of the response document output button 226 (FIG. 9).

Specific contents of this step are as described in step S430.

The response document edit/preparation processing B then terminates.

### <Response Document Edit/Preparation Processing C>

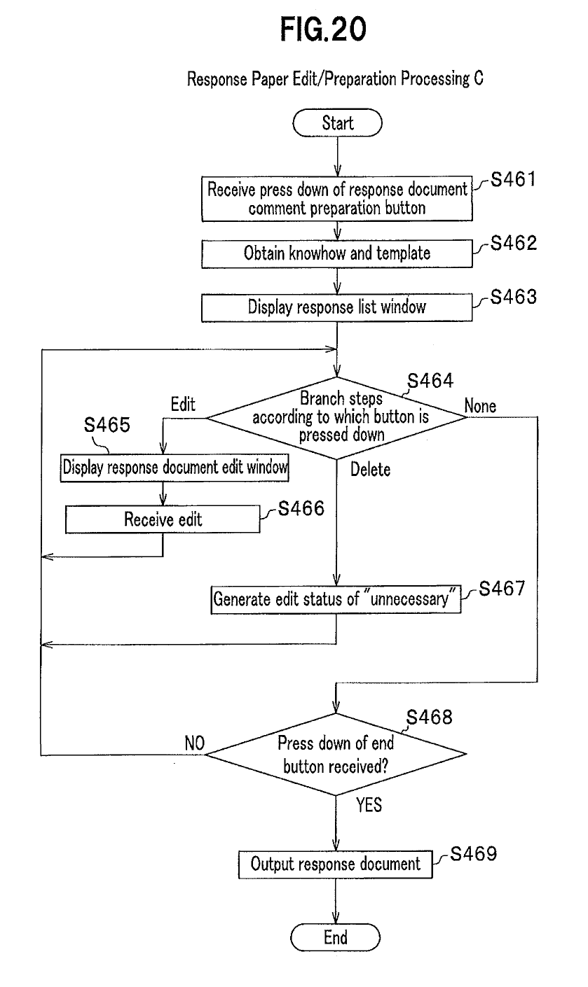

Next is described the response document edit/preparation processing C with reference to FIG. 20.

In step S461, the response document edit/preparation part 22 receives a press down of the response document comment preparation button 225.

It is assumed herein that the user presses down the response document comment preparation button 225 without selecting any critical passage in the critical passage view column 228 on the main window 51 (FIG. 9 and FIG. 10) and also without selecting any passage as a critical passage in the RFP column 229.

In step S462, the response document edit/preparation part 22 obtains a knowhow and a template.

More specifically, firstly, the response document edit/preparation part 22 searches the rule-knowhow corresponding information 36 using a combination of a rule group ID and a rule ID for identifying a rule when all critical passages displayed in the critical passage view column 228 on the main window 51 are extracted, as a search key; and obtains a knowhow ID of a corresponding record. Then the response document edit/preparation part 22 searches the knowhow database 37 using the obtained knowhow ID as a search key and obtains a knowhow of a corresponding record.

Secondly, the response document edit/preparation part 22 searches the rule-template corresponding information 38 using the combination of the rule group ID and the rule ID as a search key and obtains a template ID of a corresponding record. Then the response document edit/preparation part 22 searches the template database 39 using the obtained template ID as a search key and obtains a template of a corresponding record.

In step S463, the response document edit/preparation part 22 displays the response list window 58 (FIG. 16).

More specifically, firstly, the response document edit/preparation part 22 displays the response list window 58 of which respective columns are blank.

Secondly, the response document edit/preparation part 22 displays all critical passages (including their before and after terms and highlights) shown in the critical passage view column 228 on the main window 51, in the requirement column 302 of each record and also displays a clause of a clause title containing the corresponding critical passage, in the section column 301.

Thirdly, the response document edit/preparation part 22 displays the knowhow and the template obtained in step S462, in the knowhow column 304 and the comment column 303, respectively. At this time, the response document edit/preparation part 22 displays a critical passage, a clause title, a knowhow, and a template each corresponding to the same combination of an identical rule group ID and an identical rule ID, in an identical record.

Fourthly, the response document edit/preparation part 22 displays the edit button 305 and the delete button 306 in each record.

In step S464, the response document edit/preparation part 22 branches steps of the processing according to which button is pressed down.

More specifically, if the response document edit/preparation part 22 determines that the edit button 305 is pressed down (if “Edit” in step S464), the processing advances to step S465. If the delete button 306 (if “Delete” in step S464), to step S467. And, if neither the edit button 305 nor the delete button 306 is pressed down (if “None” in step S464), to step S468.

In step S465, the response document edit/preparation part 22 displays the response document edit window 56 (FIG. 14B).

In step S466, the response document edit/preparation part 22 receives an edit.

More specifically, the response document edit/preparation part 22 performs steps similar to steps S424 to 5429 described in the response document edit/preparation processing A.

In step S467, the response document edit/preparation part 22 generates an edit status of “unnecessary”.

More specifically, the response document edit/preparation part 22 searches the buffer record 40 (FIG. 7) using a critical passage of a record on the response list window 58 (FIG. 16) whose delete button 306 has been pressed down, as a search key, and stores the edit status “unnecessary” in the edit status column 207 of the corresponding record.

In step S468, the response document edit/preparation part 22 determines whether or not a press down of the end button 307 (FIG. 16) has been received.

More specifically, if the response document edit/preparation part 22 has received a press down of the end button 307 on the response list window 58 (if “Yes” in step S468), the processing advances to step S469. And, if not (if “No” in step S468), the processing returns to step S464.

In step S469, the response document edit/preparation part 22 outputs the response document 2 in response to a press down of the response document output button 226 (FIG. 9).

Specific contents of this step are as described in step S430.

The response document edit/preparation processing C then terminates.

### <Knowledge Edit/Preparation Processing>

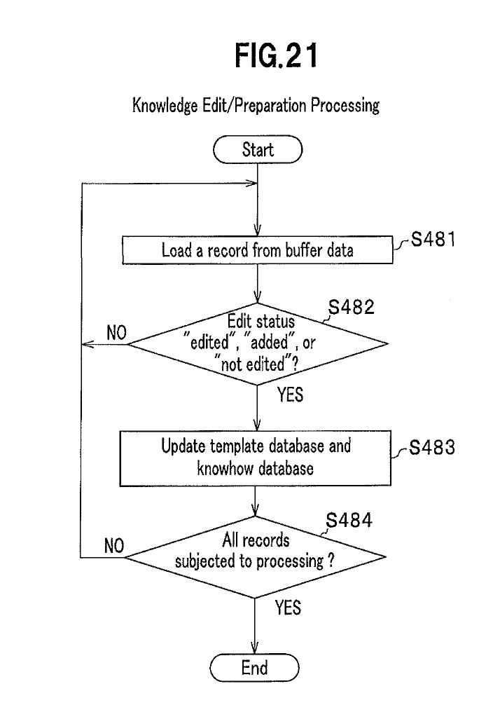

Next is described a knowledge edit/preparation processing with reference to FIG. 21.

In step S481, the knowledge edit/preparation part 23 loads a record from the buffer data 40.

More specifically, the knowledge edit/preparation part 23 loads any one record not yet subjected to the processing in the buffer data 40.

In step S482, the knowledge edit/preparation part 23 determines that an edit status of the record is any one of “edited”, “added”, or “not edited”.

More specifically, the knowledge edit/preparation part 23 determines that the edit status of the record loaded in step S481 is any one of “edited”, “added”, or “not edited” (if “Yes” in step S482), the processing advances to step S483. And, if not (if “No” in step S482), the processing returns to step S481.

In step S483, the knowledge edit/preparation part 23 updates the template database 39 and the knowhow database 37.

More specifically, firstly, the knowledge edit/preparation part 23 obtains a rule group ID, a rule ID, a response, and a knowhow of the record loaded in step S481.

Secondly, the knowledge edit/preparation part 23 creates a new record of the rule-knowhow corresponding information 36 (FIG. 5A) and stores the obtained rule group ID, the obtained rule ID, and the newly created knowhow ID, in the rule group ID column 161, the rule ID column 162, and the knowhow ID column 163, respectively. The knowledge edit/preparation part 23 further creates a new record of the knowhow database 37 (FIG. 5B) and stores the newly created knowhow ID and the obtained knowhow, in the knowhow ID column 171 and the knowhow column 172, respectively.

Thirdly, the knowledge edit/preparation part 23 creates a new record of the rule-template corresponding information 38 (FIG. 6A) stores the obtained rule group ID, the obtained rule ID, and the newly created template ID, in the rule group ID column 181, the rule ID column 182, and the template ID column 183, respectively. Then, the knowledge edit/preparation part 23 further creates a new record of the template database 39 (FIG. 6B) and stores the template ID and the obtained template, in the template ID column 191 and the template column 192, respectively.

In step S484, the knowledge edit/preparation part 23 determines whether or not all records in the buffer data 40 are subjected to the processing.

More specifically, if the knowledge edit/preparation part 23 determines that all records in the buffer data 40 are subjected to the processing (if “Yes” in step S484), the knowledge edit/preparation processing terminates. And, if not (if “No” in step S484), the processing returns to step S481.

### VARIATION

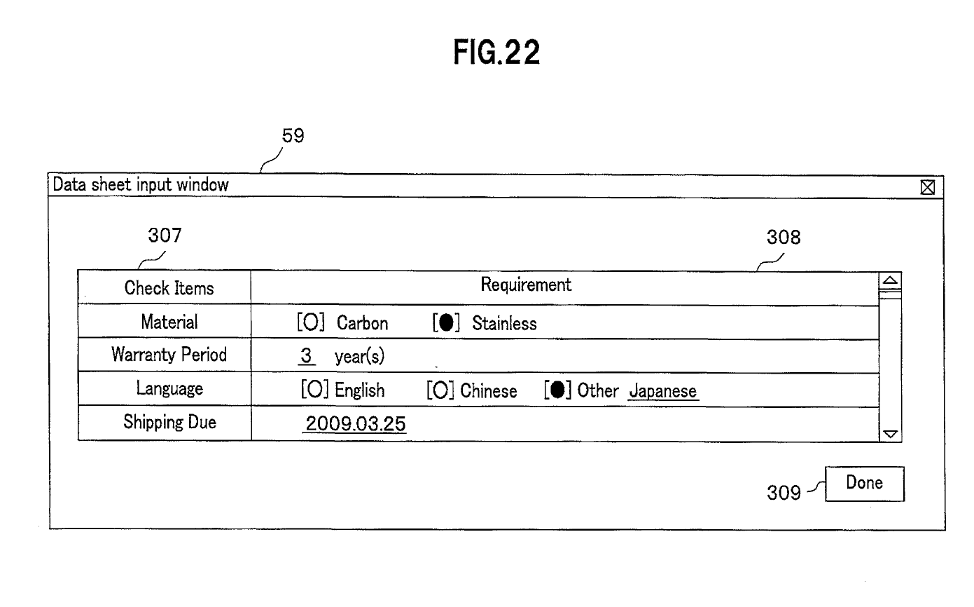

Next are described a data sheet and a data sheet input window 59 with reference to FIG. 22.

The RFP 1 is not necessarily described by sentences but may be described in tabular form. In the latter case, an input may be made in a data sheet of the document preparation support apparatus 3, instead of the RFP 1.

For example, the user looks at the data sheet in the tabular form on the data sheet input window 59 and inputs appropriate information in a requirement column 308. A check items column 307 corresponds to the clause title column 311 (FIG. 1A) of the RFP 1. The requirement column 308 corresponds to a critical passage in the clause content 312 of the RFP 1.

Referring back to FIG. 22, for example, “3 (years)” is inputted in the requirement column 308 of a row of “Warranty Period”. Similarly, “2009.03.25” is inputted in the requirement column 308 of a row of “Shipping Due”. Meanwhile, “Stainless” is selected in the requirement column 308 of a row of “Material”, from multiple options. Further, “Other” is selected in the requirement column 308 of a row of “Language” and “Japanese” is additionally inputted. Information in such a data sheet as prepared above can be used as information which can be inputted in the document preparation support apparatus 3 without specific data modification. Therefore, a configuration is possible in which the main window 51 has columns similar to those of the data sheet input window 59, instead of the critical passage view column 228 and the RFP column 229.

The embodiment according to the present invention has been explained as aforementioned. However, the embodiment of the present invention is not limited to those explanations, and those skilled in the art ascertain the essential characteristics of the present invention and can make the various modifications and variations to the present invention to adapt it to various usages and conditions without departing from the spirit and scope of the claims.

The present invention can provide a document preparation support apparatus and the like capable of supporting an efficient preparation of a contract document while utilizing information on previous contracts and knowhows and avoiding risks in contracts.

1. A document preparation support apparatus that outputs a knowhow and a response example for each critical passage of a document, comprising:
a storage unit; and
a control unit,
wherein the storage unit includes first corresponding information that stores the knowhow in association with a search key for extracting a critical passage and second corresponding information that stores an response example in association with a search key for extracting a critical passage; and
wherein the control unit:
receives the document;
extracts a critical passage from the received document using a prescribed search key from among the search keys;
searches the first corresponding information and the second corresponding information using the prescribed search key used for the extraction to obtain a knowhow and a response example; and
outputs the obtained knowhow and response example in association with the critical passage.

2. The document preparation support apparatus according to claim 1,
wherein the storage unit includes third corresponding information that previously stores therein the search keys divided into groups, and
wherein the control unit receives a user's selection of a group from among the groups and a search key from among the search keys.

3. The document preparation support apparatus according to claim 2,
wherein the control unit:
receives information selected from the document by the user, as a new critical passage;
receives an input of a search key for extracting the received new critical passage; and
stores the received search key in a group among the groups, as a record of the third corresponding information.

4. The document preparation support apparatus according to claim 1,
wherein, if a knowhow and/or a response example associated with the search key is newly created and/or edited, the control unit stores the newly created and/or edited knowhow and/or example in the storage unit in association with the search key, as a record in the first corresponding information and/or the second corresponding information.

5. The document preparation support apparatus according to claim 1,
wherein the control unit outputs a response document describing the obtained response example and a title of a clause containing the critical passage, in association with the critical passage.

6. The document preparation support apparatus according to claim 1,
wherein the document is in text format having text data converted from image data printed on a paper medium.

7. The document preparation support apparatus according to claim 1,
wherein the document is in text format in computerized tabular form.

8. A document preparation support method using a document preparation support apparatus that outputs a knowhow and a response example for each critical passage of a document,
wherein the document preparation support apparatus comprises: a storage unit; and a control unit,
wherein the storage unit includes first corresponding information that stores the knowhow in association with a search key for extracting a critical passage and second corresponding information that stores an response example in association with a search key for extracting a critical passage; and
wherein the control unit:
receives the document;
extracts a critical passage from the received document using a prescribed search key from among the search keys;
searches the first corresponding information and the second corresponding information using the prescribed search key used for the extraction to obtain a knowhow and a response example; and
outputs the obtained knowhow and response example in association with the critical passage.

9. The document preparation support method according to claim 8,
wherein the storage unit includes third corresponding information that previously stores therein the search keys divided into groups, and
wherein the control unit receives a user's selection of a group from among the groups and a search key from among the search keys.

10. The document preparation support method according to claim 9,
wherein the control unit:
receives information selected from the document by the user, as a new critical passage;
receives an input of a search key for extracting the received new critical passage; and
stores the received search key in a group among the groups, as a record of the third corresponding information.

11. The document preparation support method according to claim 8,
wherein, if a knowhow and/or a response example associated with the search key is newly created and/or edited, the control unit stores the newly created and/or edited knowhow and/or example in the storage unit in association with the search key, as a record in the first corresponding information and/or the second corresponding information.

12. The document preparation support method according to claim 8,
wherein the control unit outputs a response document describing the obtained response example and a title of a clause containing the critical passage, in association with the critical passage.

13. A document preparation support program for causing a document preparation support apparatus to output a knowhow and a response example for each critical passage of a document,
wherein the document preparation support program causes a storage unit of the document preparation support apparatus to include first corresponding information that stores the knowhow in association with a search key for extracting a critical passage and second corresponding information that stores an response example in association with a search key for extracting a critical passage; and
wherein the document preparation support program causes a control unit of the document preparation support apparatus to:
receive the document;
extract a critical passage from the received document using a prescribed search key from among the search keys;
search the first corresponding information and the second corresponding information using the prescribed search key used for the extraction to obtain a knowhow and a response example; and
output the obtained knowhow and response example in association with the critical passage.

14. The document preparation support program according to claim 13,
wherein the document preparation support program causes the storage unit to include third corresponding information that previously stores therein the search keys divided into groups, and
wherein the document preparation support program causes the control unit to receive a user's selection of a group from among the groups and a search key from among the search keys.

15. The document preparation support program according to claim 14,
wherein the document preparation support program causes the control unit to:
receive information selected from the document by the user, as a new critical passage;
receive an input of a search key for extracting the received new critical passage; and
store the received search key in a group among the groups, as a record of the third corresponding information.

16. The document preparation support program according to claim 13,
wherein, if a knowhow and/or a response example associated with the search key is newly created and/or edited, the document preparation support program causes the control unit to store the newly created and/or edited knowhow and/or example in the storage unit in association with the search key, as a record in the first corresponding information and/or the second corresponding information.

17. The document preparation support program according to claim 13,
wherein the document preparation support program causes the control unit to output a response document describing the obtained response example and a title of a clause containing the critical passage, in association with the critical passage.
